(19) United States
(12) Patent Application Publication
(10) Pub. No.: US 2007/0043804 A1
(43) Pub. Date: Feb. 22, 2007

(54) MEDIA PROCESSING SYSTEM AND METHOD

(76) Inventor: Tino Fibaek, Newport (AU)

Correspondence Address: DOV ROSENFELD, 5507 COLLEGE AVE, SUITE 2, OAKLAND, CA, 94618, US

(21) Appl. No.: 11/379,278

(22) Filed: Apr. 19, 2006

(30) Foreign Application Priority Data
Apr. 19, 2005 (AU) 2005901969

(51) Int. Cl. G06F 15/16

(52) U.S. Cl. 709/201

(57) ABSTRACT

A signal processing system including: a first processing unit including: a central hub interface receiving a stream of signal data from an external interface and forwarding the stream to one of a plurality of configurable node processing elements; a plurality of configurable node processing elements interconnected to the central hub interface for carrying out processing operations on the stream of data to produce a node output stream of data;

### RELATED APPLICATION(S)

The present invention claims priority under 35 USC 119 of Australian Provisional Application No. 2005901969 filed 19 Apr. 2005.

### BACKGROUND

1. Field of the invention

The present invention relates to the field of digital signal processing for media applications, and in particular discloses a high capacity processing engine suitable for media applications such as audio and video.

The present invention is generally applicable to the field of media production, including audio, video, film and multi-media production. It is specifically applicable to such production tasks as editing, mixing, effects processing, format conversion and pipelining of the data used in digital manipulation of the content for these media.

2. Background to Invention

Computer systems have been used for some years to process data for media applications such as audio, video, film and multi-media. Specialized hardware has been developed over this time to handle the heavy processing load. The demands of industry for more processing power have increased exponentially. At the same time, industry expects to pay less for the additional processing power.

The present invention is a new step on that path of proving more processing power at lower cost.

In addition to a need in the industry for more processing power at lower cost, there also is a need to be able to accommodate the large number of standards and proposed standards that are being touted. While supporting a larch variety of standards is clearly desirable, providing such support is not simple. To-be-supported standards, for example, might use different electrical formats, different data formats, and different underlying frequencies. Much expense has gone some devices into supporting all or almost all the standards used by different customers of a device.

Systems for processing digital media streams are known. For example, United States Patent Application Publication Number 2005/0033586 to Savell (Savell) discloses one form of ring architecture for processing a digital media stream. Due to the ring structure, the Savell architecture is inherently limiting in that data streams must continually circle the ring in order to carry out complex multistage operations. Further, ring architectures are difficult to scale to larger more complex arrangements and, apart from the parallelism introduce via their pipeline structure, the have limited parallelism capabilities.

### SUMMARY OF THE INVENTION

It is an object of the present invention to provide an improved form of digital media processor.

In accordance with a first aspect of the present invention, there is provided a signal processing system including: a first processing unit including: a central hub interface receiving a stream of signal data from an external interface and forwarding the stream to one or more of a plurality of configurable node processing elements. The plurality of configurable node processing elements are interconnected to the central hub interface for carrying out processing operations on the stream of data to produce a node output stream of data.

In one embodiment, the output stream is forwarded back to the hub from the node to form another stream of signal data for further forwarding to other node processing elements by the hub.

The central hub and the plurality of configurable node processing elements are formed in one embodiment within a Field Programmable Gate Array Device attached to a circuit board adapted for insertion into a host computer. In one embodiment, the central hub includes a dual ported memory for simultaneous receiving a first data stream and transmitting a second data stream. The central hub can be interconnected to a broadcast bus to which each of the configurable nodes can be further interconnected for the broadcasting of an output data stream to each node simultaneously. In one embodiment, the central hub includes a serial to parallel unit for receiving a plurality of return signals from the plurality of nodes and converting the return signals in parallel into an overall return signal. In an alternative implementation, there is utilized a parallel multi drop bus with each node returning data back to the hub one at a time.

Further alternative implementations use technologies such as ASICs, VLSI, or hardwired circuits in place of the field programmable gate arrays.

In accordance with a further aspect of the present invention, there is provided a host computer having a plurality of first processing units of the type previously described, the processing units being inter-networked together.

In accordance with a further aspect of the present invention, there is provided a networked computer system including a plurality of host computers networked together with each host computer further including a plurality of processing units networked together wherein the processing units are as previously described.

Each computer includes a memory element that can store instructions to cause the computer to implement one or more aspects described herein.

In particular embodiments, the data streams can include audio or video data.

The node further includes, in some embodiments, a communications portion and a processing portion, the communications portion being interconnected to the hub and including buffer storage, a processing interface including input and output ports interconnecting the buffer storage to the processing portion; the processing portion including signal processing information for processing information from the input port and outputting processed information to the output port of the processing interface.

In one embodiment, the nodes include a set of registers for storing control values. The registers are set by a host computer interacting with a host bus interconnected between a host computer and the registers.

In some embodiments, at least some of the configurable nodes are configured to include a programmable processing element, and each such node includes at least one memory element that can store instructions to cause the node to implement one or more aspects described herein.

In example embodiments, the nodes can include at least one of: an equalisation node for providing equalisation processing of the data stream; a mixing node for mixing data streams; a metering node for monitoring data value levels within the data stream; a linking node for transmitting data between different processing units; an input/output node for transmitting data from the processing unit over a network; an Audio Stream Input/Output (ASIO) node for interfacing with an ASIO device; a tracking node for providing tracking capabilities on a data stream; a delay compensation node for compensating for relative delay between multiple input streams; a dynamic node for dynamically processing a range of levels within the data stream.

Other aspects are described herein.

### BRIEF DESCRIPTION OF THE DRAWINGS

Preferred forms of the present invention will now be described by way of example only, with reference to the accompanying drawings in which:

FIG. 1 illustrates schematically the formation of one embodiment on an FPGA card for connection to a host computer;

FIG. 2 illustrates schematically multiple FPGA cards inserted into a host computer;

FIG. 3 illustrates schematically the interconnection of multiple hosts in accordance with the teachings of an embodiment of the present invention;

FIG. 4 illustrates schematically more detail of an embodiment;

FIG. 5 illustrates schematically the hub-node interface of one embodiment;

FIG. 6 illustrates schematically the process of loading registers in each hub;

FIG. 7 illustrates schematically one form of operations of one embodiment;

FIG. 8 illustrates schematically a corresponding mapping from FIG. 8 to the FPGA structure of one embodiment;

FIG. 9 illustrates schematically one example operation of one embodiment;

FIG. 10 illustrates schematically the operation of a mixer node;

FIG. 11 illustrates schematically the operation of a meter node;

FIG. 12 illustrates schematically the operation of a linking node;

FIG. 13 is a clocking diagram utilized in data transfers by a linking node;

FIG. 14 illustrates schematically the operation of the ASIO node;

FIG. 15 illustrates schematically a track interface node of one embodiment;

FIG. 16 illustrates schematically an interpolation process of one embodiment;

FIG. 17 illustrates schematically the operation of the delay compensation node of one embodiment;

FIG. 18 illustrates schematically the operation of the dynamic range processing node of one embodiment;

FIG. 19 is a flow chart of the dynamic compensation process;

FIG. 20 illustrates schematically one form of implementation of the flow chart of FIG. 19;

FIG. 21 illustrates the target calculation process of FIG. 20 in more detail;

FIG. 22 illustrates the equalization process of one embodiment;

FIG. 23 illustrates schematically a miscellaneous processing node of one embodiment;

FIG. 24 illustrates schematically an implementation of the arrangement of FIG. 23;

FIG. 25 illustrates schematically the use of one embodiment in a production environment;

FIG. 26 illustrates schematically the use of one embodiment in a production environment;

FIG. 27 illustrates schematically a process of clock generation;

FIG. 28 illustrates schematically a process of clock generation;

FIG. 29 illustrates schematically a process of clock distribution;

FIG. 30 is a clock diagram of information distribution;

FIG. 31 illustrates schematically the process of clock recovery.

### PREFERRED AND OTHER EMBODIMENTS

One embodiment of the present invention includes a media processing engine which configures or reconfigures electronic processing components to redistribute their functionality according to need between any type of mathematical/logical processing of media data, and pipelining of that data between processing units.

One embodiment is based around a Field Programmable Gate Array (FPGA) device that includes a media processing engine hereinafter called the “Crystal Media Engine,” or simply “CME” or simply “Crystal processor.” Such media processing engine is included in a suitably configured, e.g., field programmed high-end FPGA device such as those available from Altera or Xilinx.

This specification is written to a person of ordinary skill in the art of media processing, computer architecture, and programming, so such a person would be expected to be readily familiar with how to design for FPGAs, and how to carry out field programming of FPGA type devices, e.g., to configure different nodes. Whilst one arrangement utilizes FPGA technology, it will be clear to those skilled in the art that other technologies could alternatively or in conjunction be used, such as hardwired circuits, VLSI technology, or ASIC technology.

Depending on requirements and current technologies, multiple Crystal Media Engines can be accommodates on one or multiple FPGA device, or on multiple FPGA devices, on a board containing one or more FPGA devices.

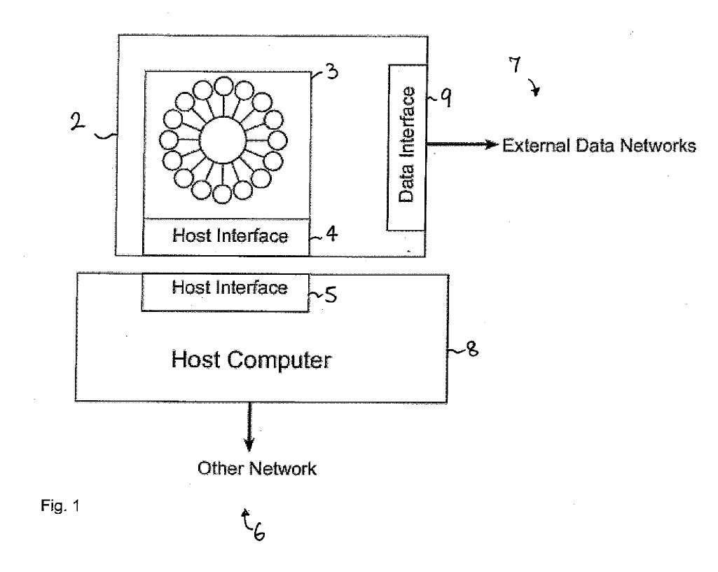

Turning initially to FIG. 1, there is illustrated one example arrangement of one embodiment. In this arrangement a Crystal Media Engine 3 is formed within a single FPGA on a PCI card 2. The card 2 includes a PCI Bus Interface 4 for communicating with the outside world and, in particular, with a host computer 8 which in one version is a high end PC system having a PCI Bus Interface with associated PCI interfaces as slots for PCI cards. Alternatively, instead of a PCI Bus interface, a computer with other forms of bus interface can be used, such as PCI-E, PCI-X, Firewire or another type of bus. The card 2 includes a further external interface 9 for connecting to an external data network 7. The host computer 8 can also be interconnected with other networks.

Crystal Core—Media Processing Engine

The Crystal Media Engine, e.g., 3 is designed to process a large number of inputted signals in parallel, performing different functions on each signal. An example of this is a digital audio stream in which many simultaneous channels—signals—must be given individual treatment such as tone balancing, volume control and different echoes. All these audio channels must maintain their synchronicity with each other to a very high degree of accuracy, so all the processing for every sample of every channel must be accomplished by the system within one sample period, typically 1/48000^{th} of a second, but in some cases down to 1/384000^{th} as with the DSD audio format. Whilst the Crystal Media Engine arrangement can be used to operate on other digital signal streams such as video, film and multi-media applications, audio is used as the example throughout this specification.

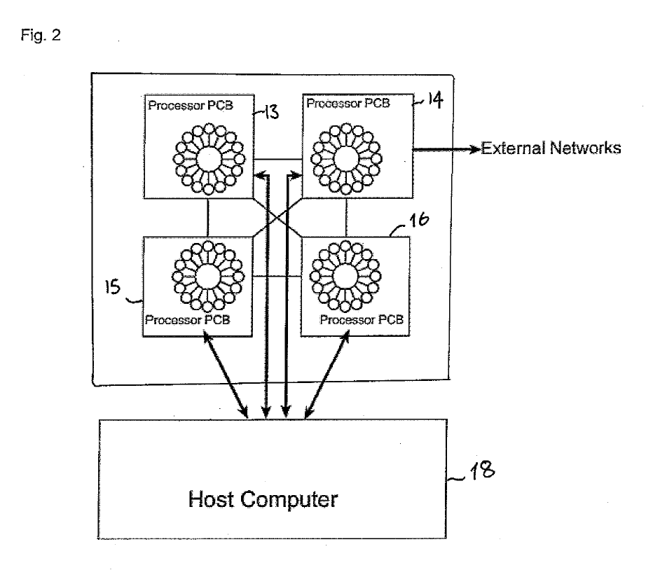

The Crystal Media Engine (CME) 3 is formed with an FPGA which is in turn connected to a suitable host computer. The smallest engine is a single board in a PC. A medium system is a host computer with four circuit boards. Such an arrangement is illustrated in FIG. 2 wherein 4 Crystal Media Engines 13-16 each having a host bus interconnect are inserted into corresponding host bus slots in host computer 18. Each CME can have a number of “ringway” interconnections, e.g., 19 to other CME devices.

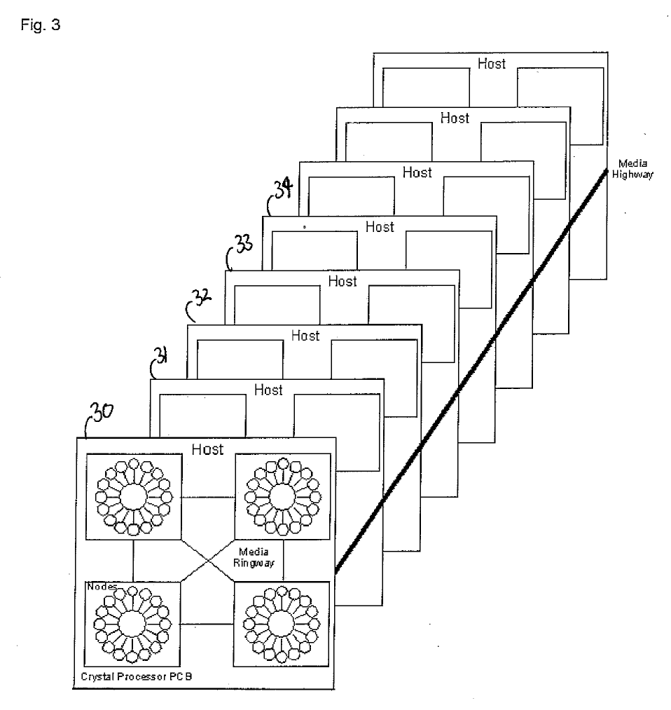

Further, by interconnecting host computers, larger arrangements can be formed. For example, as illustrated in FIG. 3, host computers, e.g., 30-35 each containing four Crystal Media Engines can be further interconnected.

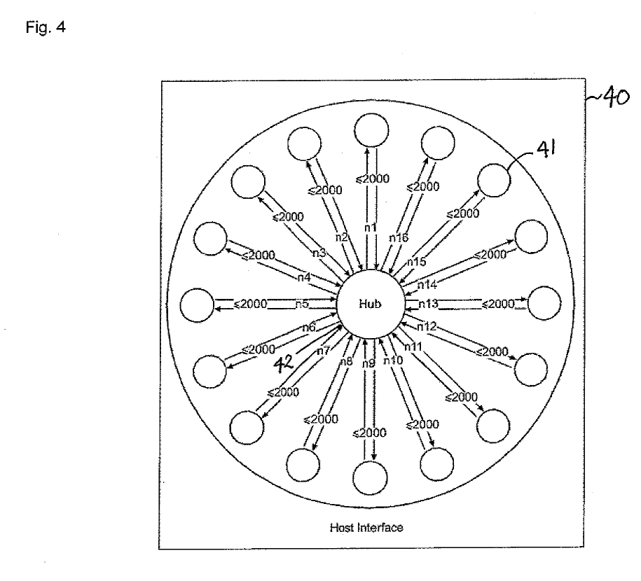

As illustrated in FIG. 4, each CME 40 consists of a number of nodes, e.g., 41, arranged around a central hub 42. The nodes and hub are interconnected—not shown in FIG. 4—to their corresponding host computer via PCI Interface 42.

The fundamental operations of each CME is processing and connectivity. Processing means mathematically defined and logical operations, thousands of which can be performed on audio samples, each, e.g., a single digital number, to allow them to be manipulated as intended by the operator. Processing is carried out in the nodes 41 which are formed out of the logic circuits of the FPGA by loading appropriate processing algorithms into each node as will become apparent herein below. Once a program is loaded, that node of the FPGA is temporarily dedicated to the program's processing function, e.g., a plurality of operations designed to achieve one kind of effect.

Connectivity in this context means getting the correct signals to the correct processing node. For example, in an audio system with 200 source channels, there may be more than 1000 actual channels being processed and routed to different destinations, since each channel must be handled before and after each of its multiple stages of processing. This routing requirement consumes a considerable amount of computer resources.

Thus the processing and connectivity requirements must be balanced against each other when designing the CME.

The Crystal Media Engine is able to allocate both processing and routing resources flexibly to different processing nodes as needed, allowing all its power to be distributed effectively. Each processing node can be individually configured for its specialized function, and the “size” of the node, or its cost in hardware resources can be flexibly determined. A simple node performing input and output functions may use a fraction of the resources of a complex node like a multi-channel equalizer, and the system can allow precisely the right amount of resources to be allocated to each task. This means that resource usage can be optimized, so the maximum possible number of signals can be brought to their appropriate node processors and transformed, e.g., according to a mathematical set of operation(s) and/or logical operation(s). This reduces any waste of resources and thereby reduces system cost and increases flexibility. Flexibility is provided with respect to both processing and routing, e.g., a mixing node may receive 256 input signals from the hub, but might only return 64. Likewise, a metering node may receive 128 signals but return none.

The CME architecture allows for almost limitless expansion. It can connect multiple circuit boards within a single computer, or multiple computers, fusing them into a single system of immense power. In addition, its reconfigurable allocation of channel connections to processing nodes ensures the flexibility to make full use of the processing power.

Total Studio Connectivity Protocol (TSCP)

Modern studios and post production houses are equipped with a variety of devices performing different jobs. These include sound mixers, vision mixers, color correctors, signal processing equipment, recording devices and so on. Very often these devices are linked together to form a system in which they will be used together for a specific project. When this happens, connections must be made between the devices so that the data they are processing can be instantly piped from one device to another. Interfaces between different devices depend on standards such as electrical format, data format and timing signals. Many such standards exist and are required to be followed for different projects, depending on the needs of the customer. Currently, building a studio involves a large amount of wiring to be installed, supporting a large number of different interface standards. Wiring a complete facility magnifies the scope of the problem many fold.

The inventor recognized that there are fewer computer interconnects types used in practice than end user audio and video interconnect types. Thus, by using standard computer interconnects, much of the complexity of studio wiring is eliminated by handling multiple standards simultaneously, using the standard computer type network interconnections. This can be complemented by distributing a single master clock—a timing signal—to all connected devices. Each such device can recover a synchronized master clock signal from the distributed clock and used to generate local clock signals in any required formats.

Large System Architecture

As noted previously, the overall Processing Engine is made up of CME Processor circuit boards mounted in host computers. Each circuit board carries a single high density FPGA (Field Programmable Gate Array). In this example, each host computer carries up to four circuit boards. The basic system would therefore consist of a single host housing a single Crystal Processor. Expansion of the system would first add more Crystal Processors to the first host, then increase the number of hosts, each carrying up to four Crystal Processors. Such a system is illustrated in FIG. 3, with the connection between circuit boards called a Media Ringway 35, while that between hosts is called a Media Highway 36. Together the Media Ringway 35 and Media Highway 36 provide for using a new ultra high-speed connectivity protocol.

FIG. 3 shows a large system consisting of multiple hosts, each containing four Crystal Processors. There is no theoretical limit to the number of hosts in a system, the practical limit being governed by the number of data channels to be transferred around the system. As the system grows, connectivity becomes indirect, i.e., a signal traveling from node A to node B might have to travel via intermediate nodes.

Processor Chip

The Crystal architecture is based on the use of high-density Logic chips such as FPGAs (Field Programmable Gate Arrays). Of course, it would be obvious to those skilled in the art that it could alternatively be implemented in the form of an ASIC (Application Specific Integrated Circuit), a true VLSI circuit, or hardwired circuits. Each FPGA contains millions of simple logic parts, that can either statically or dynamically upload instructions that configures those parts into complex arrangements for high-speed computer applications. One embodiment uses an FPGA in replace of media signal processing hardware such as dedicated components or partially-programmable digital hardware.

FPGAs can be field configured to form a great variety of standard logic components and I/O ports that can be built into complex sub-systems. FPGA configurations can even embed whole processors exactly emulating commonly-used DSPs or CPUs into a part of the chip while other parts function differently. It is thus possible, with the addition of a few extra components such as RAM and some standard computer bus interface chips, to build a complete system using one field configurable device. Memory also can be configured into the FPGA

A FPGA can upload partial algorithms while in operation, allowing continuous reconfiguration while operating. This is particularly useful in the context of a user controlled system, where tasks change during a session. It is even possible to take a system down and completely reconfigure it to change from, say, a large scale audio mixer into a video color correction device, in a matter of seconds.

Hub and Nodes

The FPGA logic elements can be configured utilizing a suitable high level language such as VHDL to form a hub-node structure, wherein a single hub connects a number of nodes, typically up to sixteen, with 11 nodes as illustrated in FIG. 4. The Hub 42 is the signal routing core, effectively a switching matrix with a scalable bandwidth. A typical large audio mixing system may use hubs switching 2000 by 2000 audio signals of 36-bit depth at 48000 samples per second, or its data equivalent in other media or at other sample rates. Larger hubs may be configured as needed.

Hub-Node Data Transfer Interface

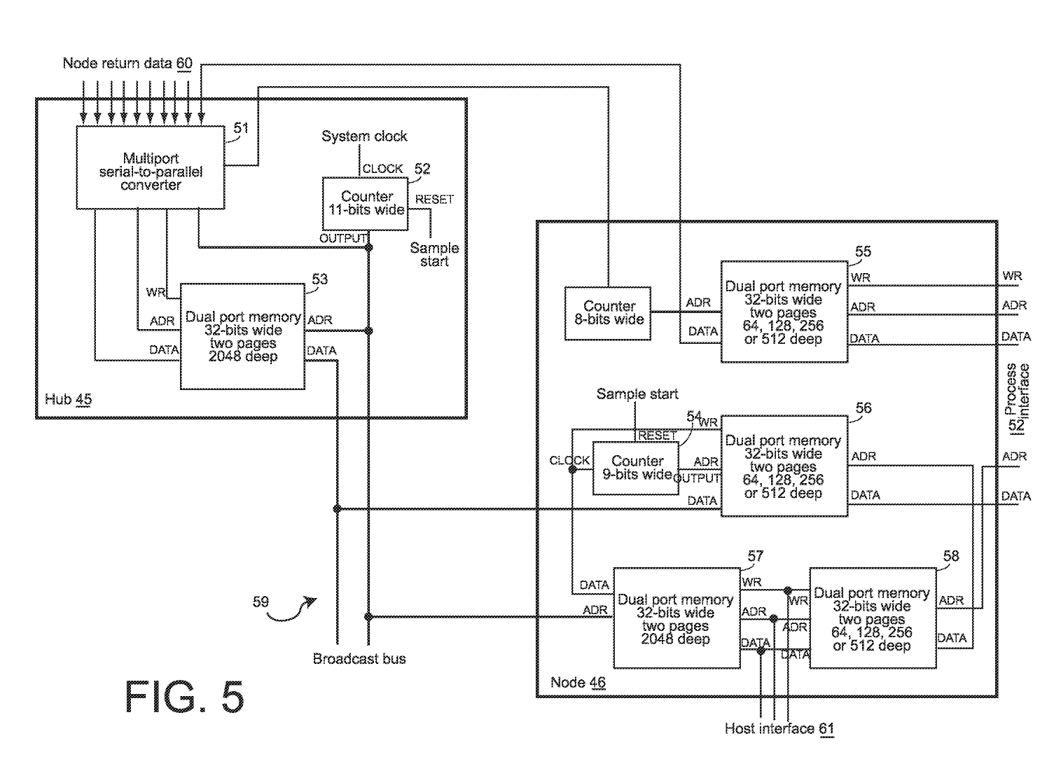

FIG. 5 illustrates the hub and node data transfer interface structure. There are two connections between the hub, e.g., 45 and node, e.g., 46. Data is sent to the node using a broadcast bus 59 consisting of 36 data bits and 11 address bits. Data is returned from the node to the hub using a serial connection 47. Optionally, a parallel return path can be provided.

One embodiment includes in the hub a dual port memory block 53. In one embodiment, this is 36 bits wide, 2048 entries long, and two pages deep. During one sample period, while one page is being read, the other page can be written. In one embodiment, the two pages swap functions at the beginning of each sample period.

At the beginning of the sample period, the counter 52 is reset. It then starts counting up at a frequency of 100 MHz. This counter is used as the address on the read side of the hub memory 53. The sample that is read out of the memory 53, and its address, are broadcast to all nodes via the broadcast bus 59.

Configurable routing can be achieved in two stages: The memory block 57 is used as a notification register, with each entry telling the node 46 if it does or does not want the data currently present on the broadcast bus. If the node does want the data, the node's local address counter 54 is incremented after the data has been written to memory 56. The other half of the routing is done via the memory block 58. All reads done from the node by the process block happen “indirectly” by remapping of the read address.

The node routing mechanism has a link 61 to the PCI host interface, allowing the host computer to configure it. Both memory blocks 57, 58 associated with the routing are pages; whenever the routing changes, both memory blocks must be updated synchronously.

The memory block 56 is designed to holds the data going from the broadcast bus to the processing block accessible via process interface 52. One page can be written from the broadcast bus, while the other page is read by the node's process. The two pages swap functions at the beginning of each sample period.

Data going from the process to the hub is written into one page of memory block 55, whilst the other page is read serially by the hub's serial-to-parallel interface 60. This serial line can be from 1 to 36 bits wide, depending how the amount of resources that can be allocated.

A serial to parallel converter 52 is responsible for gathering the samples from the individual nodes, and writing them to the 2^{nd} page of the hub's memory 53. The samples are written back in a fixed mapping.

Node Operation

The Process Interface 52 is a simple memory to memory exchange of data that allows data samples to be read, processed and returned.

Nodes can be configured during architecture definition, e.g., using a hardware description language, to perform any computational or transmission function needed by a product. Several examples of node designs are explained in detail below. Some of these node functions use a node that includes a programmable processor, and one embodiment of such a node includes a memory for storing instructions for the node's programmable processor.

Dynamic Resolution Optimization

In an initial example, in a large system performing many different operations, it is sometimes desirable to give more precision to some operations than others. In the field of digital audio, for example, it is known that low frequency filters, because they accumulate data over a long period, also accumulate errors which can be significant if very high precision is not used. Examples of this problem are discussed by Greg Duckett and Terry Pennington of Rane Audio, in their paper “Superior Audio Requires Floating Point”, published on the Rane Audio website http://www.rane.com/note153.html and by Andy Moorer, a pioneering digital audio engineer, in an article is called 48-BIT INTEGER PROCESSING BEATS 32-BIT FLOATING POINT FOR PROFESSIONAL AUDIO APPLICATIONS and can be found at http://www.jamminpower.com/PDF/48-bit%20Audio.htm

The problem with having a requirement for high-precision processing somewhere in a system is that it is not needed everywhere. One of the advantages of one embodiment of the invention is that each node is effectively an independent processing system. Thus it is possible to create a filter running in 72 bits of precision if so desired, while the rest of the audio in the system is running in 36 bit floating point.

At other places in the system, even 36 bits is far too much precision. For example, mixer coefficients lie in a predictable range that can comfortably be expressed with significantly less than 36 bits, and the system may be storing and transmitting hundreds of these. The flexibility of configuring and re-configuring in the Crystal Media node architecture allows for any size of data word to be used in any context, thus allowing the more expensive processing hardware only where it is needed, while remaining economical elsewhere.

Host Bus

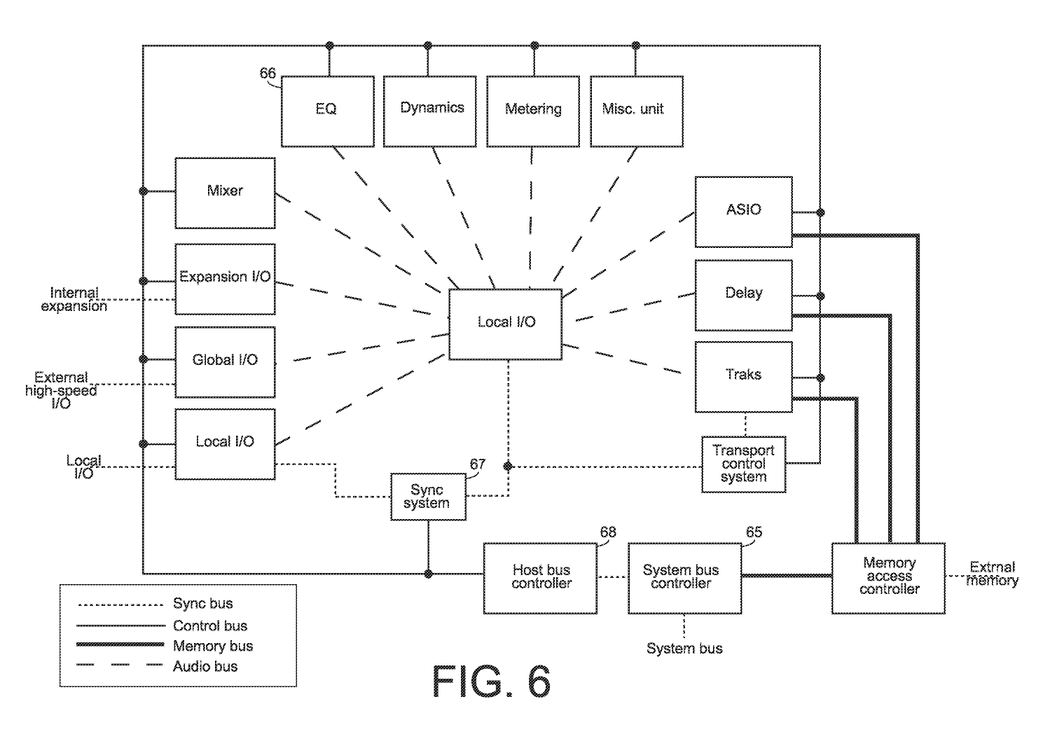

Turning now to FIG. 6, interaction between the host computer and the CME is needed whenever control values, e.g., 67 within a node, e.g., 66 are required to be changed. This can be provided by a separate Host Bus 65 is used to allow access from the host computer processor to all nodes and their memory registers simultaneously.

The Host Bus 65 can be a configurable, on-chip bus which is able to access and update blocks of memory used by the nodes for value storage. The term “host register” is used to denote memory accessed in this way. Their contents typically include control parameters to be applied to samples of program data. A bridge 68, in one embodiment on the FPGA device, and in another embodiment, off the FPGA device, can be used to exchange data with an external bus such as PCI, PCI-X or PCI-E, depending on the type of host used in the system.

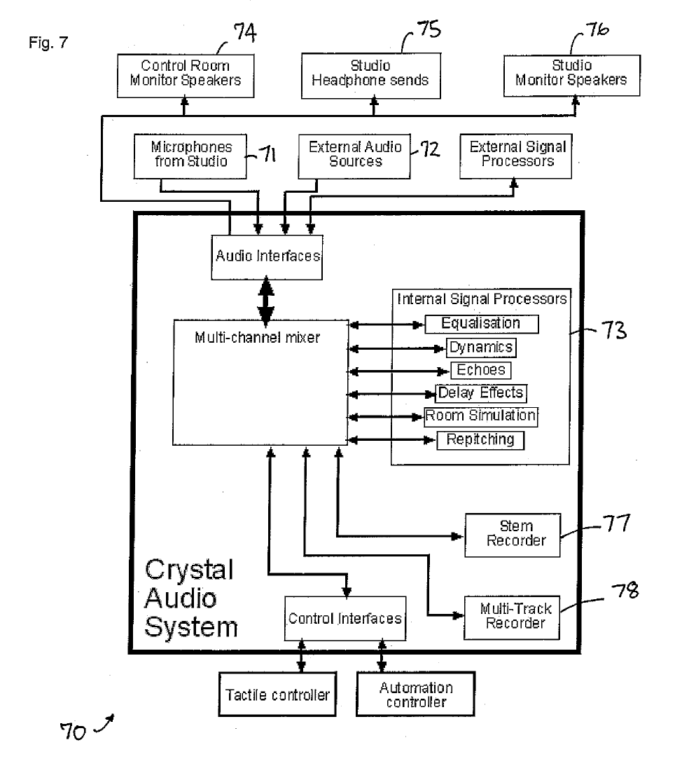

An example system utilizing the CME technology will now be described initially with reference to FIG. 7. The example is a large audio mixing system 70 located in a multi-room post production house, whose business is editing video and creating audio soundtracks. The mixing system is capable of taking feeds from a number of sources including microphones 71 and External Audio Sources 72, process them individually 73 as regards EQ, Dynamics, Echoes, Delays and other effects, and then produce a number of mixes, or sums of those feeds, and directing them to different destinations such as speakers 74-76, or recording devices 77, 78 as required.

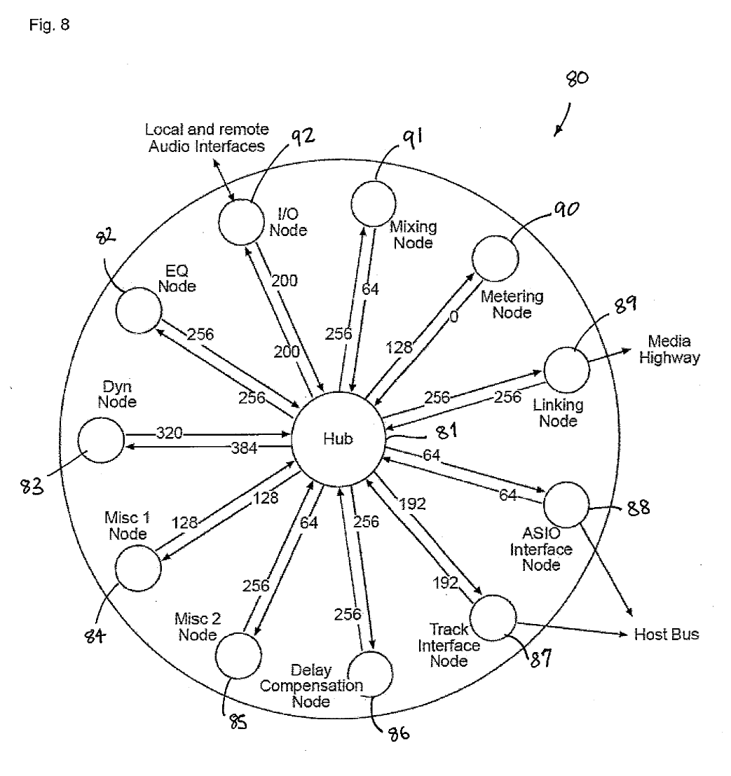

As shown in FIG. 8, the mixing system 79, 73 is implemented using a Hub-Node architecture. As explained earlier, the hub 81 acts as a signal routing core, effectively a switching matrix with scalable bandwidth. Its function in this system is to pass audio samples between the processing Nodes 82-92. Each node is in turn connected to a computation or I/O process via its process interface (52 of FIG. 5).

Each of the Nodes 82-92 is a signal processing station, programmable to perform any floating point computational or I/O task required by the user's current application. Such a signal processing station includes a memory to store instructions that cause the station to implement the required task. The nodes used in the mixing application are: Mixing 91, Metering 90, I/O 92, Linking 89, ASIO Interface 88, Track Interface 87, Delay Compensation 86, Dynamics 83, Equalisation (EQ) 82, Miscellaneous 1 (Oscillator and Monitoring) 84 and Miscellaneous 2 (Plug-in Playground) 85.

Each node has access to the hub's full signal bandwidth, in this case 2000+ channels, which are delivered on the hub's Broadcast Bus. All nodes have this access simultaneously, but are provisioned as part of their configuring with just enough virtual memory and logic to receive the exact subset of channels needed to perform the node's current task. The ability to precisely control the bandwidth to each node liberates power within the FPGA for other needs, thereby making efficient use of its capacity.

Each node 82-92 returns signals to the Hub for further processing or transfer. The number returned by each node depends on the task being performed, controlled by the node's configuring. For example, a metering node may receive 128 channels from the hub, but it returns none of them, since its output is metering information, not audio. The total returns for all nodes may not exceed the hub's maximum, in this case 2000 channels. The Return Bus (47 of FIG. 5) is a point to point or shared connection from a Node to the Hub and may be configured as serial or parallel links.

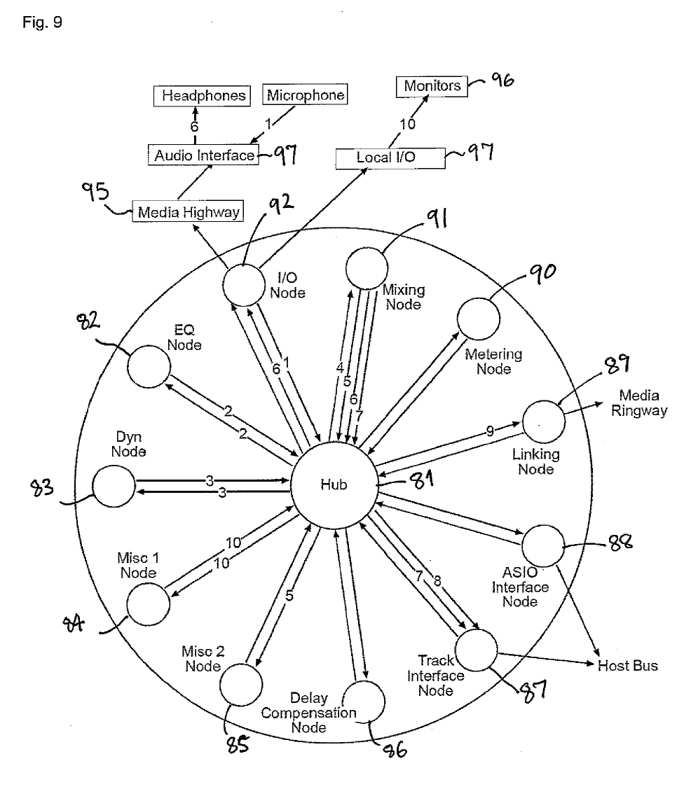

FIG. 9 illustrates a typical example signal path. In this example, an actor is recording post-sync dialog for a video production, in sync with a video picture displayed on monitors 99, and with other elements of the soundtrack. The voice is captured by a microphone 96, whose output is digitized, and then:
1) The digitized microphone signal enters an audio interface 97, where it is forwarded by the media highway 95 to I/O node 92 wherein it becomes a Live Feed and is forwarded to the Hub 81.
2) Live Feed is sent to Equalization Node 82 for improvement of tone, and back to the Hub.
3) The Equalized Live Feed is then sent to Dynamics Node 83 for level smoothing, and back to the Hub.
4) Smoothed Live Feed is sent to Mixer node 91, where it is added to a mix of other audio feeds and sent back to the Hub.
5) This mix goes on to the Misc 2 node 85 where it is filtered to produce some room ambience, so that they all sound as if they happened in the same room. This room ambience is sent back to the Hub 81, then back to the Mixer Node 91 to be included in the Stem Mix (not shown).
6) At the same time the Live Feed is added to a different mix of other audio feeds, sent back to the Hub and on to the Audio Interface 97 and thence to the actor's headphones.
7) At the same time the Live Feed is added to a different mix of other audio feeds, sent back to the Hub and on to the Stem Recorder via track interface node 87 for a temporary mix that can be played later for the director.
8) At the same time the unequalized Live Feed is sent to the Multi-Track recorder via track interface node 87 so that its processing can be examined before the final mix.
9) At the same time the unequalized Live Feed is sent to a second CME card for further processing. This is done via the Linking Node 89 and its associated Media Highway, where it is recorded on a video machine to be played for the producer.
10) The stem mix is also sent to the Misc 1 node 84 to be included in the Monitor mix. This is returned to the Hub, and output via the I/O Node 92 to speakers.
   Details of Nodes

The operation of the processing section of each node will now be described in more detail.

Audio Mixing Node

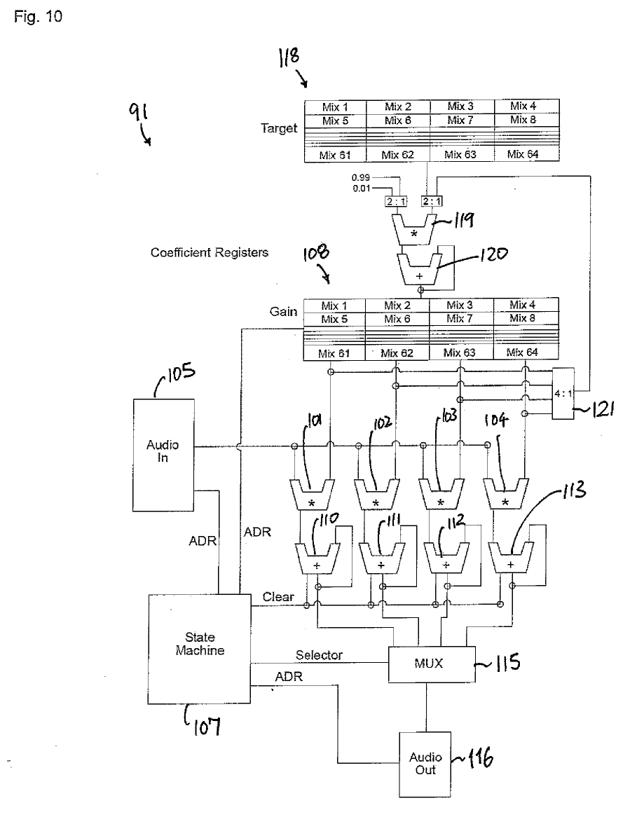

Referring to FIG. 10, there is shown schematically the processing portions of the Audio mixing node 91. The node is based around a parallel set of four, or in some embodiments, more than four multiplier-adder pairs 101-104 that are configured into the hardware to form the core of an engine capable of producing typically 64 independent mixes of 256 source channels, running at a clock speed of 200 MHz with an audio sample rate of 48000 Hz.

During each instruction cycle, one audio sample is sent from audio in store 105, corresponding to store 58 of FIG. 5, to the left input of all four multipliers to create four of the 256×64 mix elements. A State Machine 107 is responsible for generating the address of this audio sample, plus the addresses of the gain coefficients 108 for that audio sample in the first four mixes. The products of the multipliers are sent to the adders 110-113 where they are added to the previous adder outputs. In the next instruction cycle the State Machine increments the audio input so that the next channel's mix products are added to the four mixes being accumulated in the adders.

After 256 instruction cycles the four mixes are complete. The MUX 115 acts as a four into one switch, which selects the four finished mixes one by one and writes them into the Audio Out memory 116, equivalent to Memory 55 of FIG. 5. At this point the Adders 110-113 are cleared ready to start accumulating the next four mixes.

The Coefficient Registers 108 hold the mixing coefficients for each of the 256×64 mix elements. These are updated as needed by the Host, interfacing with the registers via the Host Bus. The active coefficients are those in the Gain register. When the user interface changes the value of a coefficient, it cannot be immediately applied without risking a noticeable artifact in the audio. For this reason it is written into a separate register called a Target register 118. An adder 120 and multiplier 119 are positioned between the two registers, then, over two instruction cycles, one Gain register value is updated as follows:
Gain=Gain*0.99+Target*0.01

The current Gain value is switched by a 4:1 multiplexer 121 into the right multiplier input, while the value 0.99 is read into the other input. The product of these two is forwarded to the Adder 120. In the next instruction, the corresponding Target Value is read into the right multiplier input with the value 0.01. This product is added to the previous product in the adder, and the result written to the corresponding Gain register 108. At this point the 4:1 multiplexer 121 will choose the next gain value. Because these gain values are already being read into the mixer core, no special memory read is required to obtain them.

Thus each Gain coefficient will gradually asymptote towards the Target value, while maintaining the integrity of the audio signal. Because a gain value is read each second instruction cycle, while the mixer is producing four mix components in the same period, the coefficient update process is effectively running at one-eighth the speed of the mixer. Therefore it takes eight samples for all coefficients to take one step towards their target values. In small seconds all coefficients have reached 90% of their target values. In another 5 milliseconds they have advanced by 90% of the remainder.

Metering Node 90

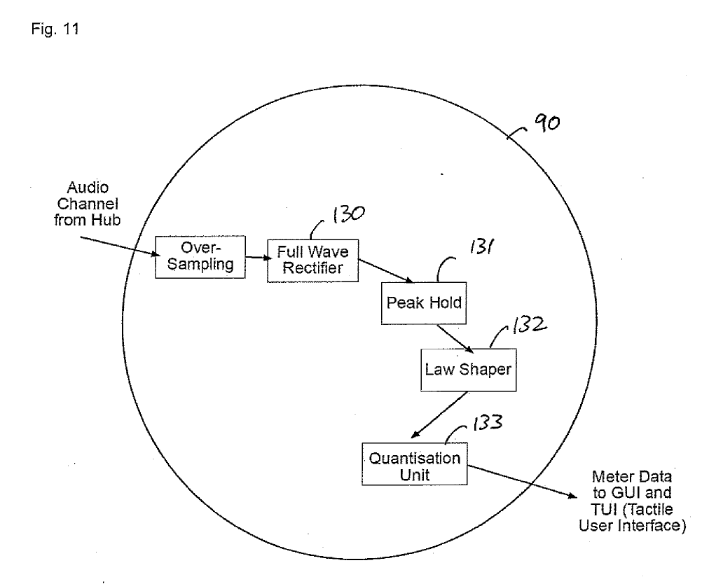

The operation of the metering node can be as illustrated in FIG. 11. The node takes 128 signals from the hub and provides data to be displayed on the user's screen (GUI) or using LED indicators on a tactile controller.

Each signal from the hub is super sampled before passing through a full wave rectifier 130, to convert all values to positive ones, then into a peak hold logic element 131 that stores the value of the largest audio sample during the metering period. The metering period in one embodiment is set according to the type of meter being fed with this data.

The Law Shaper 132 converts the data into the appropriate metering law chosen by the user i.e., VU, PPM, BBC or Peak. The quantization unit 133 converts the data into the number of steps being shown by the meter. The data is then fed to the host bus and to a hardware controller interface for display on the host computer and the tactile interface respectively.

Linking Node 89

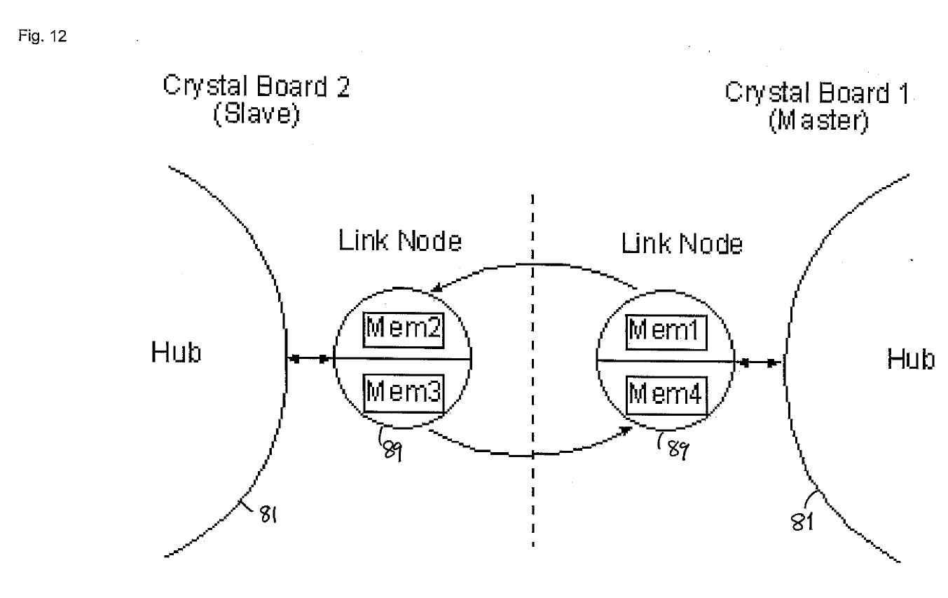

The Linking node 89 is illustrated in FIG. 12 and is responsible for transmitting and receiving data channels via the Media Ringway, used for data transfer between circuit boards. The Media Ringway provides a dedicated, serial, point to point hardware interface.

Each Media Ringway connection is capable of transmitting 200 audio channels of 36 bit width, at a sample rate of 48000 Hz, yielding payload bandwidth of 345 Mbits/sec. Each board is equipped with six Media Ringway connectors.

Data is transmitted from Mem 1 on the Master Board to Mem 2 on the Slave Board. Transmission is synchronized to a Word Clock signal derived from the Master Board. This Word Clock is recovered by the Slave board from the first transmission then used to synchronize the return signal path from Mem 3 to Mem 4.

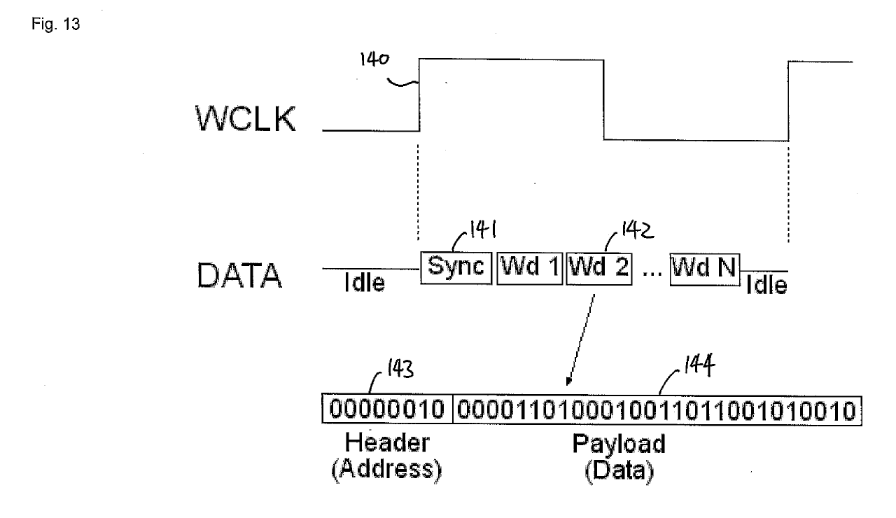

The data is organized into bursts as shown in FIG. 13. Upon the rise 140 of the WCLK signal, a Sync word 141 is sent, identifying the Word Clock start. This is immediately followed by a plurality of data words, e.g., 142, after which the channel goes idle until the start of the next WCLK.

The data word is organized as a Header 143 containing the sequence number of the word, plus a payload 144 of channel information. The payload uses a standard Ethernet 4B/5B encoding scheme with built-in clock recovery, allowing the receive device to correctly synchronize to the send device's bit-clock, which is necessary for correct decoding of the data.

The sending device is always the bit-clock master for the transmission, so for the example shown, in the initial path from Mem 1 to Mem 2, Crystal Board 1 is the bit-clock master, while in the return path from Mem 3 to Mem 4, Crystal Board 2 is the bit-clock master. This clock is based on the timing for the FPGA processor chip, which runs nominally at 200 MHz in this example. In fact the timing clocks can vary slightly from board to board, meaning that the send and receive paths are asynchronous with each other. The data is collected by each receiving device during the WCLK period, then allowed to idle until the next rise of WCLK, when all devices are effectively re-synchronized.

I/O Node 92

The I/O node is responsible for processing the external fast connection, Media Highway, which works similarly to Media Ringway, but links separate computers, I/O boxes and other Crystal architecture devices. Media Highway is the technology used to create the Total Studio Connectivity Protocol (TSCP). The I/O node can provide data rate and/or format conversion capabilities.

ASIO Interface Node 88

ASIO (Audio Stream Input/Output) is a real-time interface developed by Steinberg Soft-und Hardware GmbH. It is designed to allow independent applications to interface to Steinberg and other products which run purely on a computer host such as a PC or Macintosh.

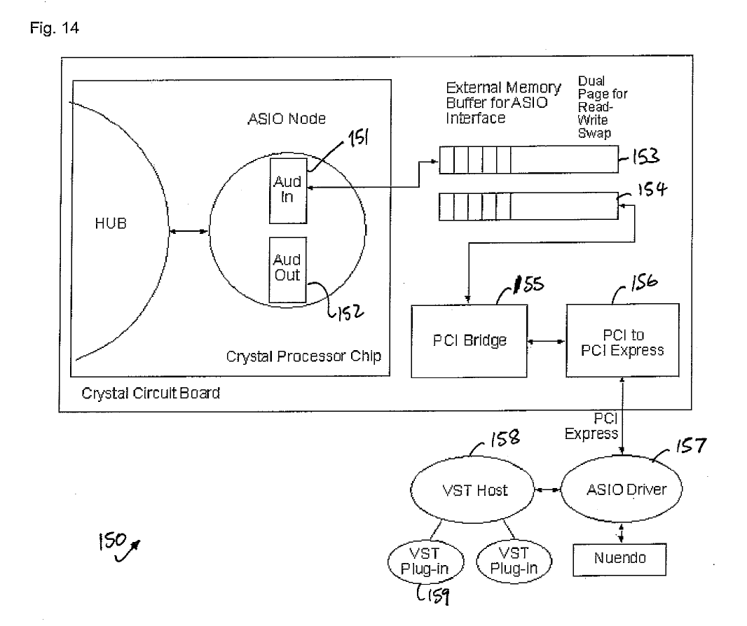

The ASIO interface node structure can be as illustrated in FIG. 14. A pair of memory buffers 153, 154 is used for the ASIO interface. The ASIO node 88 on the Crystal processor is responsible for reading and writing samples to and from the ASIO buffers 153, 154. The external memory 153, 154 is accessible to the host computer's main data bus, in this example the PCI or PCI-Express bus commonly used in today's PCs. This interface can be 155 achieved using a dedicated PCI interface chip, and if needed a PCI to PCI-Express chip 156. An ASIO driver 157 running on the host computer sends messages to ASIO functions, e.g., 158 operating in its environment, informing them of the memory address where their next block of audio samples for reading or writing is located.

VST plugins 159 are audio processing modules running in the host environment, which can be accessed via the ASIO interface. Each process includes a degree of delay, as its input audio stream is collected into buffers, processed, passed back to its origin as buffers, then clocked out into the audio stream. Often the delay is immaterial, as when the processing involves production of reverberation and other time-domain effects, or when the product being processed is going to be the final output of the system. In cases where signals are processed and then mixed back into the system with other signals that must be time-aligned, the VST plug-in can provide a statement of its system delay, which can be used by the CME as a guide to the correct settings for the Delay Compensation node described hereinafter.

Track Interface Node 87

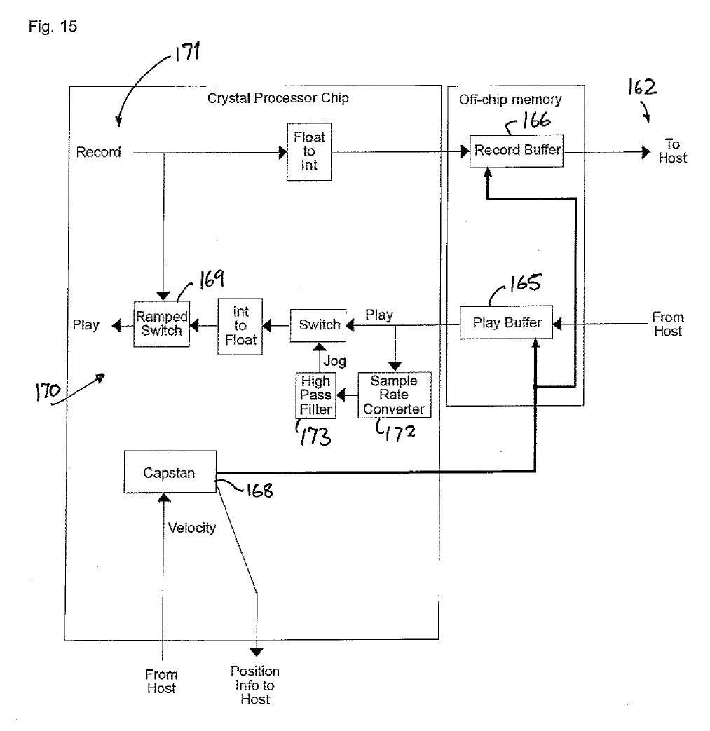

The Track Interface Node is illustrated in more detail in FIG. 15. This node implements up to 192 tracks of recording and playback. Each playback track has one or more streams, each an independent sequence of audio samples, so that the system can implement crossfades of any length desired by the user. Note that crossfades are used to smooth edit transitions between different pieces of audio source material.

The host computer is responsible for fetching playback samples from disk, and for writing record samples to disk. Playback samples are fetched from disk in two streams 160, 161, and are processed to add Equalization 162 and variable Level control 163 (“Rubber Banding”), prior to being mixed 164 and placed in the Play Buffer 165 which can be a circular buffer holding approximately 10 seconds of audio before and after the point where audio is being played. This process is non-real time, occurring before the system plays the audio, and the host is responsible for keeping the buffer filled up around the play point. The recording samples are placed in the Record buffer 166 by the CME, and are written to disk 162 in blocks. The Record buffer is also a circular buffer, but only forward movements through it are relevant.

The system is said to have “transport modes” which include Record, Play and Jog. The host controls a Capstan 168, which indicates the velocity of the system, which may vary from typically −3 to +3 times play speed. Velocity is akin to forwards or backwards playback speed, and the results are analogous to the behavior of a tape recorder, which pitches up and down according to its speed. The Capstan calculates the read and write positions of the Play and Record buffers respectively based on the current velocity, and it returns the current position to the host for display and synchronization purposes.

When the system is in Play Mode, the capstan speed is set to +1, and audio samples are read at exactly the sample rate at which they were recorded, then sent directly from the buffer to the play input of the mixing system. The Recording system is off at that time, so no samples are being written to disk, but they are being written to the Recording buffer 166, ready to enter Record. The system may enter Record at any moment the user chooses, whereupon the system begins writing samples to disk 162 from the Recording buffer.

The Track Node includes a Ramped Switch 169 which allows the Play output 170 hear the Record path 171 instead of the samples from the Playback buffer. The system can switch monitoring (listening) from the Play path to the Record path or vice versa whenever required, e.g., usually when the system enters or leaves Record mode, and it ramps, e.g., crossfades between the two signals over many samples to avoid pops caused by big differences between successive sample values.

When the system enters a Jog mode, Recording is switched off, and samples stop being written to the recording buffer 166. At this time a Switch in the CME causes the output of the Jog circuit to enter the Play path.

The Capstan is now given a velocity of other than +1 by the host, so it changes the rate, and optionally the direction, of read point movement in the buffer. Note that the write point in the Record buffer is inactive during jog, because no samples are being written. At the same time, the rate of samples generated from the buffer is tripled to 3 times the sample rate. This does not mean that three times as many samples are needed in the buffer—on the contrary, the absolute value of Jog velocity is usually less than 1, so the buffer need not be filled as quickly as during Play. The extra samples are created by linearly interpolating samples in the buffer, based on sub-sample movement directed by the Capstan. Note that linear interpolation does not yield the best audio quality, but in Jog mode this is not required.

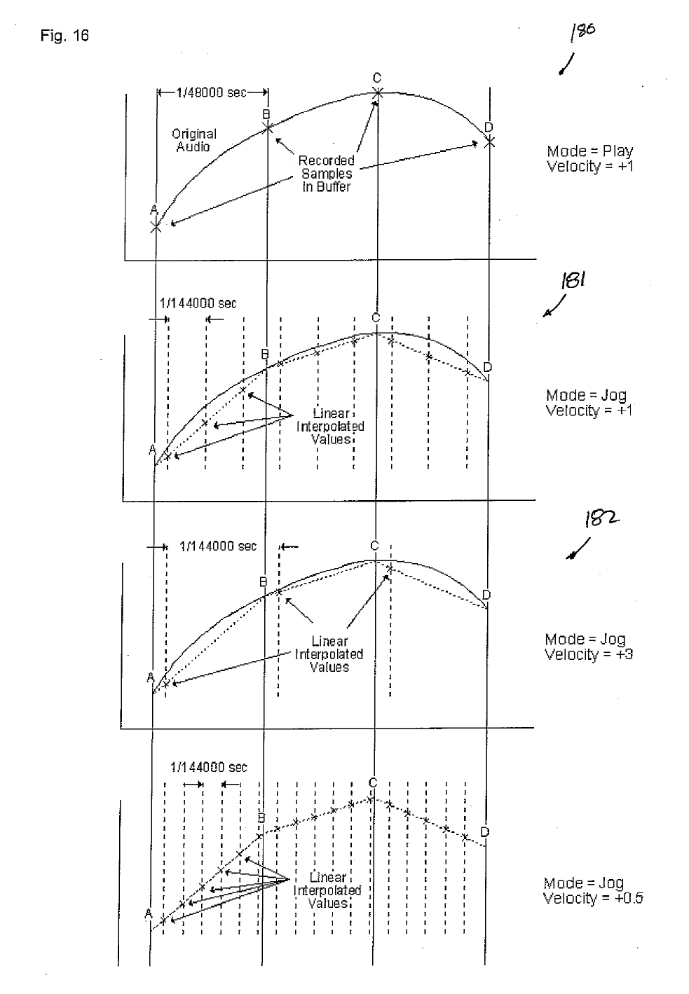

An example of this process will now be discussed with reference to FIG. 16. As shown initially 180, in Play mode the samples are read directly from the Play Buffer, forming the stream ABCD.

In Jog mode 181 three times as many samples are read in the same period of time. The system calculates a value based on a linear interpolation of the recorded samples before and after the read position. All values calculated this way are interpolated, as a read position will almost never fall exactly on a sample boundary.

In the example 182 where Velocity=+3, the read positions, e.g., 183 are exactly one sample apart, but not aligned with the samples. To make the interpolations, the system must read the sample behind the read point, and the sample in front of it. These reads are requested by the system immediately before each interpolation, but if either of the samples has already been read in order to perform the previous interpolation, it is not read again. The worst case read would require 4 samples to generate three interpolated values, but this would not be sustained, and the average peak reading rate cannot exceed 3 samples per interpolation.

In the examples where Velocity=+1, the reads are one-third of a sample apart. Where Velocity is +0.5, the reads are one-sixth of a sample apart.

The read values are fed to a sample rate converter (172 of FIG. 15), which performs a further linear interpolation of those values to generate the required sample rate. The sample rate conversion factor is the reciprocal of the velocity, divided by three. Filtration of the converted samples is performed by a gentle low pass filter 173 running at around 18 kHz. Because the samples are read at an effective sample rate of 144 kHz, yielding a Nyquist frequency of 72 kHz, the low pass filter at 18 kHz does not need to be very steep, since there is virtually no chance of aliasing. This has the effect of providing good audio quality in Jog mode, while eliminating the expense and potential artifacts associated with the brick-wall filters traditionally used for anti-aliasing.

Delay Compensation Node 86

The Delay Compensation node equalizes the delays introduced into individual signal paths, by delaying all signal paths by exactly enough to synchronize them with the most-delayed channel. For example, if the biggest delay of any signal path is 100 samples, then another signal path delayed by only 30 samples must be given an additional 70 sample delay.

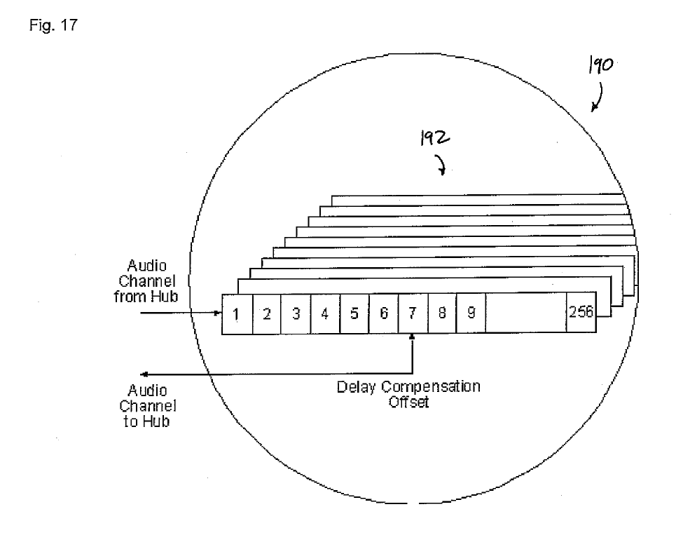

The Delay Compensation Node is illustrated 190 in FIG. 17 and works by writing audio samples into a first-in-first out memory buffer 192 large enough to hold the longest expected delay. At the beginning of each sample period the oldest audio sample is dropped from the buffer and a new one inserted. During that sample period, a sample is read from a position in the buffer n positions from the point where new samples are being inserted. N is called the Delay Compensation Offset. This sample is now delayed by n sample periods, and is returned to the hub. Two sample periods are required to move the sample from the hub to the Delay Compensation Node and back again, so these must be considered when calculating the Delay Compensation Offset.

Dynamics Node 83

Dynamics is a process that control the range of levels within an audio stream. Four kinds of dynamic range control are commonly used in the audio industry, and are be handled in the Dynamics Node they include compression, limiting, expansion and gain markup.

Compression is a process whereby the absolute level of the audio is attenuated once it exceeds a fixed threshold. The amount by which it is attenuated is given by the compression ratio, always less than unity, where attenuation=compression ratio*(Level−Threshold), when Level>Threshold.

Limiting is a process whereby the absolute level in an audio channel is prevented from exceeding a fixed number. In practice Limiting can be thought of as an extension to Compression, where the Compression Ratio is extremely high. In theory the ratio is infinitely high, and in practice, around 100.

Expansion is a process whereby the differences between audio levels are increased. It works in the opposite sense to compression i.e., when the audio level falls below a threshold, the difference between it and the threshold are multiplied by an expansion ratio, of more than one. So quiet signals, judged unimportant, are made even quieter so that they will distract even less from important ones. The extreme behavior of expansion is called gating, where the expansion ratio is so high, typically more than 100, that the audio below the threshold is virtually made silent. An additional control called Range is introduced to prevent the audio dropping by more than a fixed amount, regardless of the expansion ratio.

Gain Makeup is used to counteract the gain loss introduced by compression. It is a fixed amount of positive gain, i.e., more than unity, which changes the description of compression from “bring all signals above threshold down to match the others” to “bring everything up so it is equally loud”.

Time Behavior

All dynamics processes have time built into their behavior. When a threshold is crossed and the process begins to act, it cannot act immediately, or the audio would suffer from ringing, popping and other artifacts. Instead, an “attack time” is defined during which the dynamics process ramps from no effect to achieving its goal.

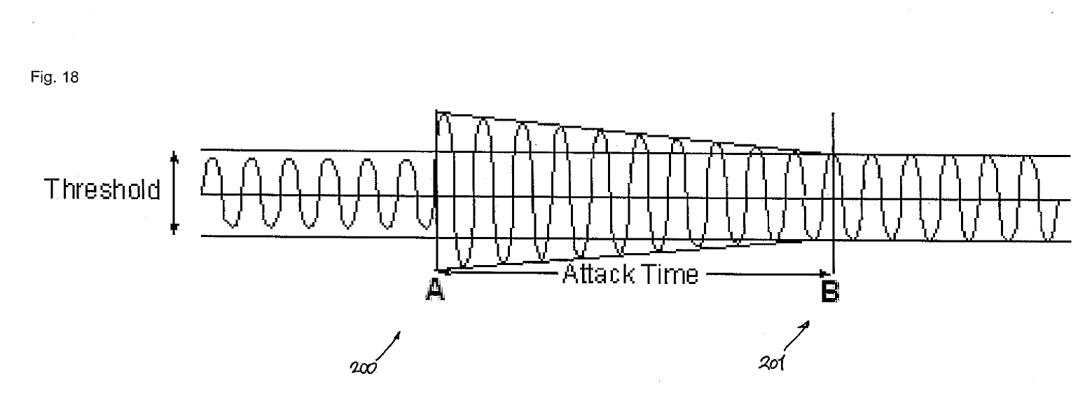

An example of Limiter Attack Behavior is shown in FIG. 18. The audio signal exceeds a threshold at time A (200). The Limiter reduces the level until, at time B (201), it is equal to the Threshold. The attack time is the time interval between A and B. Although the diagram shows the level change as linear, in practice other limiting techniques such as logarithmic limiting can be used.

Each process also has a release time, which controls what happens when the audio level crosses back to the non-active side of the threshold i.e., below threshold for compressor and limiter, or above threshold for gate. The attenuation of the process, which has been reducing the gain while the audio level is on the active side of the threshold, now ramps towards zero.

Real audio signals vary wildly in level, so dynamics processes are constantly changing their target attenuations, and constantly ramping towards their changing targets.

Chained Processing

The dynamics processor node applies all three processes to each audio channel. Typically the gate is first. Its output is fed to the compressor, whose output in turn is sent to the limiter. The limiter threshold would normally be higher than the compression threshold, and its attack time is generally faster. The gate threshold is typically much lower than the compression threshold, but its attack time may be faster or slower.

Side Chains

Sometimes it is desirable to control the attenuation of an audio channel not according to its own level, but according to the level in another channel. A simple example is “ducking” where the level of a music background is lowered when a voice-over is active. In this case a compressor or an inverse gate may be used, with the music background as the main or affected channel, and the voice over as the trigger or side-chain channel. Another example is de-essing, where over-active sibilants are attenuated by compressing the main vocal with a different version of itself where the non-sibilant frequencies have been removed.

Side chaining in a large audio system is largely a matter of routing the correct signals to the correct locations in a circuit i.e., the affected channel is fed through the gain circuitry that performs the attenuation, while the trigger signal is fed through the circuitry that measures the level and calculates the required gain.

Stems

Audio channels are sometimes grouped as “stems”. The simplest example is a stereo signal, where the left and right channels form a 2 channel stem. Other examples occur in surround sound mixing, where, for example, all the sound effects for all the surround channels—up to 6 channels in some embodiments-are sub-mixed together before being mixed with other components such as dialog and music. This effects sub-mix would be referred to as a 6-channel stem.

When dynamics is applied to a stem, it is normal to use the same gain value on all elements of the stem, even though they are not equally loud. To understand why this is necessary, imagine a stereo music track where the main vocal is “centered” i.e., equally loud in left and right channels, and a loud cymbal crash occurs in the left channel. If the dynamics for the two channels were not linked, the left channel alone might be attenuated, causing the vocal image to drift to the right, just while the cymbal is sounding. This would be disturbing to the listener, so it is normal to treat both channels with the same attenuation, derived from whichever channel is loudest at any one moment. This is also true when applying dynamics to stems wider than 2 channels.

Dynamics Node Overview

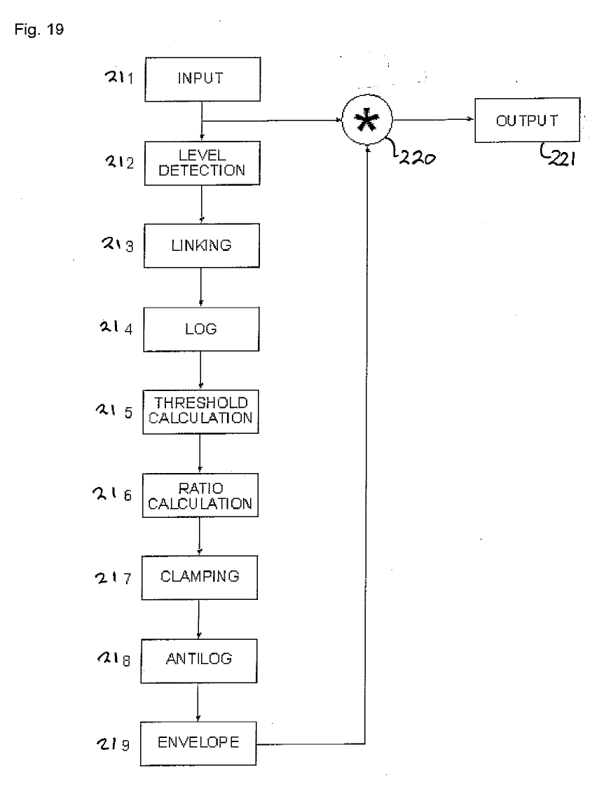

FIG. 19 illustrates the flow data in the dynamics node operation:

Audio samples are written from the hub to an Input Register 211, corresponding with the channels to be smoothed, and the channels used in Side Chains.

In the Level Detection stage 212, the audio samples are processed to extract the level information that will be used to calculate the gain needed for each sample.

Linking 213 is the decision process used for stems i.e., a single gain coefficient will be used for all members of the stem, and this step works out which element has the highest level and ensures that its level will be used for the gain calculation.

Levels are moved into the logarithm domain 214. Measurements of audio level are calibrated logarithmically i.e., in decibels (dB) because human hearing responds logarithmically to it. Dynamic range control is therefore specified logarithmically, and the calculation of gain coefficients is more efficient in that domain.

Threshold calculation 215 determines by how much the level in a process exceeds or falls short of the threshold for that process.

Step 216 applies the ratio for a process to the amount by which the level exceeds or falls short of the threshold in that process, to determine its gain coefficient.

Clamping 217 removes gain coefficients which are out of the allowable range. For example, compression and limiting gain coefficients must always reduce level, while expander/gate coefficients cannot reduce the level by more than the Range parameter in that process.

In step 218, the calculated gain values are converted back to the linear domain so they can be applied to the audio samples.

In step 219, the envelope or resultant gain of the three dynamics processes are multiplied together into a single gain factor that will be applied to the sample.

Dynamics Node Hardware Arrangement

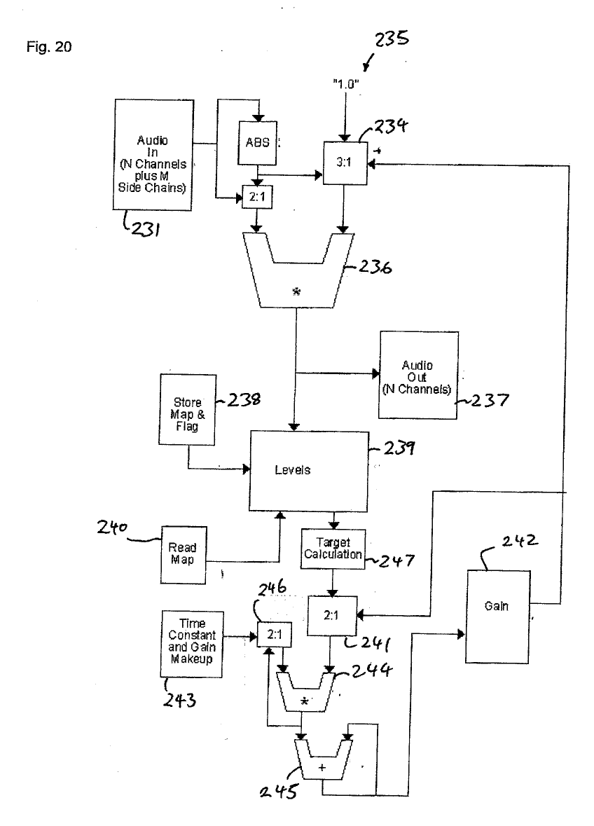

Referring to FIG. 20, there is shown one hardware arrangement of the Dynamics Node suitable for implementing the flow of FIG. 19. The basic process applies a gain (multiplier) 242 to each sample from the Audio Input 231 and stores it in the Audio Output 237. During each sample period this operation will be performed for all the Input channels, typically up to 300 in a large audio system, that are selected by the user for dynamics control. The multiplier labeled 236 performs all these basic gain multiplications, and many other multiplications required to evaluate gains.

The basic gain multiplication has a sample from Audio in 231 switched through the multiplexer at 233 into the left side of the multiplier at 236. The correct gain value for that sample is sourced from the Gain values registry at 242, switched through the multiplexer at 234 and fed to the right side of the multiplier at 236. The product is fed to the Audio Out memory 237, from where it will be sent back to the hub for use by other nodes.

The rest of the Dynamics node operation is concerned with calculation of the correct gain value for each sample. The gain value is affected by all three processes—gate, compressor and limiter—and by the attack/release times for each of them.

Since gain values are a function of the current level in the audio channels, these must be collected and stored in each sample period. The levels for the three processes are evaluated differently. The level for the gate process is calculated as follows: the audio sample from Audio Input (231) is fed to the RMS circuit (232) which determines its absolute value. From there it is switched (233) into the left side of the multiplier (236). The value 1.0 is read from memory (235) and switched (234) to the right side of the multiplier. The product is stored in the Level register (239) at an address determined by the Store Map and Flag (238). The use of Store Map and Flag is described below.

Compressor level values must be squared before use, since most compressors work on an RMS (root mean square) determination of level. To bring this about, the Audio Input sample (231) is sent to ABS (232) to extract its absolute value, then fed to the left side of the multiplier (236) via one switch (233) and also to the right side via another switch (234). The resulting square is stored in the level register (239).

The limiter follows the compressor, so its level value must be derived from that of the compressor. This is calculated by taking the gain for the compressor, from the gain register (242) and feeding it to the right side of the multiplier (236) via a switch (234). This is multiplied by the absolute value of the Input sample (231, via 232 and 233 to left side of 236), and the product stored in the Level register (239).

As explained earlier, gain values are ramped towards their target values, from their current values, stored in the Gain Register (242). Targets are calculated in the circuitry for item 247 (Target Calculation). This is explained in more detail below.

The current gain value for a process, stored in the Gain Register (242) is fed to the multiplier (244) via a switch (241). Here it is multiplied by a value related to the attack or release time of the process, which is accessed from the Time Constant and Gain Makeup register (13). For example, given an attack time of 10 milliseconds, e.g., 480 samples at a sample rate of 48000 Hz, we would expect the process to have reached its target gain in 480 samples. Hence the Time Constant would be 1/480, and the Complementary Time Constant would be 1- 1/480. So the current gain is multiplied by the Complementary Time Constant and fed to the left input of the adder (245). Here it is added to zero and the result fed back to the right side of the adder, where it is added to the Time Constant multiplied (244) by the Target gain from Target Calculation (247). The result of this addition is fed to the Gain Register (242) to be used for the main gain calculation for the process. It will also be used as the input of the next gain ramping operation just described.

All process gains are stored in the Gain Register via successive iterations of the above computation. When all are completed, they are fed one at a time to the multiplier (244). The second gain is multiplied by the first, which is switched (246) to the left multiplier input. Then the third is brought in and multiplied by the product of the first two. The result of this calculation is multiplied by the gain makeup from (243) and is now a single gain representing the total dynamics effect. This will be switched (244) into the main multiplier (236) with the next audio sample and the product of this multiplication written to Audio Output (237).

Store Map and Flag

When stems are being processed, it is necessary to use a single gain value for all elements of the stem, as described earlier. The mechanism requires that the largest value for the Audio Inputs of the stem elements be used to calculate the gain value that will be used for all of them.

The Store Map 238 generates addresses for the level values of the input channels in the Level Register (239). It uses a flag to determine whether storage of a value is unconditional (normal) or conditional, e.g., only stored if larger than the value currently stored. When a stem comes up for level evaluation, the value determined for the first element is stored unconditionally in the next available memory slot. The level values determined for the second and subsequent elements are stored in the same memory slot, but only if larger than the value currently stored there. This ensures that only a single level value is used to determine the gain, and that it is the largest of the element levels for each sample period.

Target Calculation 247

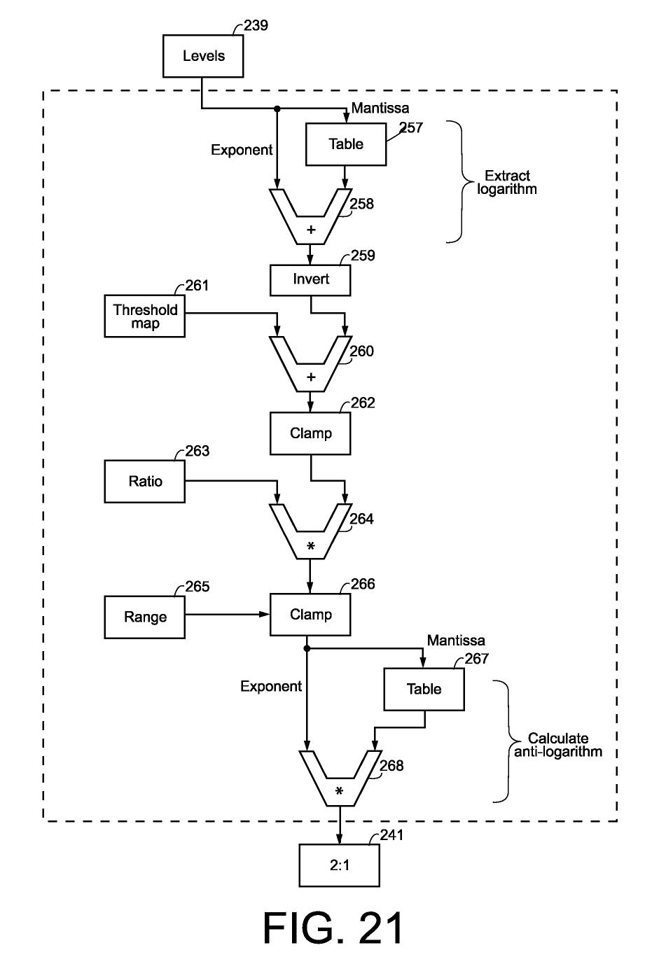

FIG. 21 illustrates the hardware operation for the Target Calculation 247 for Dynamics Node. The Audio Level for a process, which was stored in the Levels register (239) from the Dynamics Node diagram, is initially converted into a logarithm. The number is split into Exponent and Mantissa. In one embodiment, each level has been stored as a 36 bit number using an 8 bit exponent and 28 bit mantissa. To make this calculation the Exponent is added 258 to the logarithm of the Mantissa, which is obtained via a 7-bit lookup table of values 257. Note that the accuracy requirements for gain calculations, given a constantly changing signal level, are not very exacting, and this method gives an accuracy of better than 0.1%.

Inversion from positive to negative is the next phase 259. This is done for the Expansion/Gating process, but not for Compression or Limiting. This is because the action of expansion depends on how far below a threshold the level is, while the action of Compression and Limiting depend on how far above the threshold the level is. In the adder at position 260, the calculated level is added to the Threshold 261. In one embodiment, the Threshold 261 is stored as a negative number for Compression and Limiting. The difference is thereby obtained.

For Compression and Limiting, a negative difference i.e., audio below threshold must produce a gain of unity, i.e., zero dB so any negative result for these processes is clamped to zero at position 266.

For Expansion/Gating, a gain more negative than the Range is clamped to the Range value at position 265.

Now the gain value is returned to linear space using an anti-logarithm algorithm. The mantissa, which is the mantissa of the logarithm of the gain value, is converted to linear space using a lookup table 267, then multiplied 268 by the exponent, which becomes a power during conversion to linear space. The result is fed to switch 241, whose function is described previously.

Equalization (EQ) Node 82

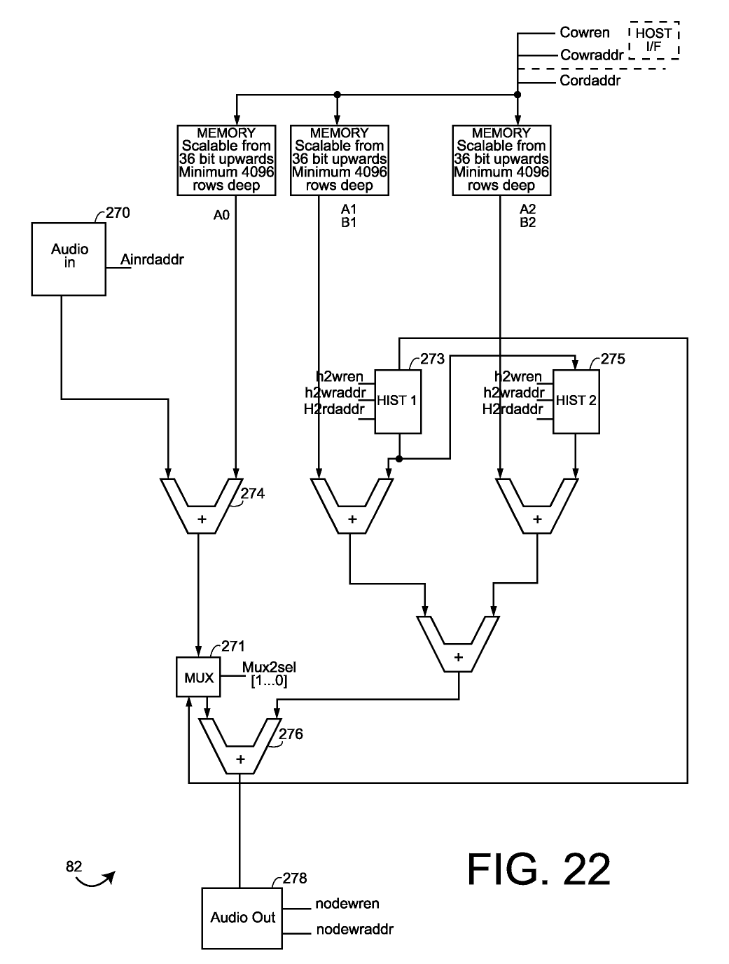

FIG. 22 illustrates an example EQ node which creates a standard IIR filter (infinite impulse response) commonly used in the audio industry. The same basic architecture can be used with different algorithms to create FIR and other useful filters. This design implements the following algorithm for one band of an IIR filter:

Cycle 1, with the multiplexer switched to input mode:
H=Audio In* A0+A1* HIST1+A2* HIST2

Cycle 2, with the multiplexer switch to accumulate mode:
Audio Out=H+B1* HIST1+B2* HIST2

And at the same time, HIST1 is copied to HIST2, and HIST1 is itself updated

A0, A1, A2, B1 and B2 are coefficients calculated from the user-related parameters of the equalizer band, such as turnover frequency, slope or Q-factor, type of filter, e.g., whether lo-pass, hi-pass, bandpass, and gain. These coefficients are calculated by the host computer and transferred into the EQ node memory using the Host Bus.

The foregoing algorithm represents one of eight equalization bands applied to each channel. The results of each band are fed back to the beginning of the algorithm for the next band to be applied: Mux 1 switches it back into the first multiplier to execute the first instruction of the algorithm. After eight bands of equalization the audio sample is sent to the output and the next channel is processed, Mux 1 switches in the next audio sample from Audio In. Running at 200 MHz, this architecture delivers 256 channels of 8-band equalizers at a sample rate of 48000, when running at 200 MHz.

Miscellaneous 1 Node (Oscillator and Monitoring) 84

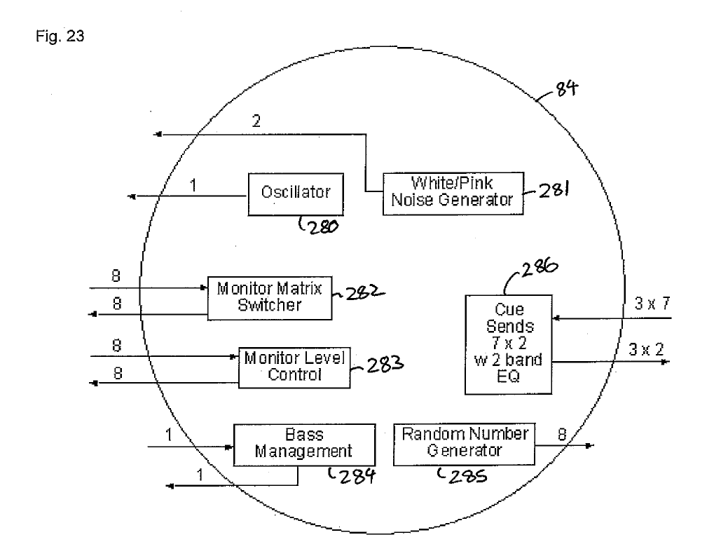

The Misc 1 Node 84 is illustrated in more detail in FIG. 23 and provides the following functions:
a) Oscillator 280—used for checking signal paths through a system.
b) White and Pink Noise generator 281—used for external equipment frequency response tests
c) Monitor Matrix Switched 282—used to combine elements of Surround Sound audio to be listened to in different formats.
d) Monitor Level Control 283—controls the loudness of Surround Sound audio through the speakers
e) Bass Management 284—creates the subwoofer channel by summing the other signals then filters it to remove unwanted high frequency audio
f) Cue sends 286 (up to 3)—each send produces a stereo fold-down mix of the Surround Sound audio plus a talkback facility, for a headphone signal
g) Random number generator 285—used for dithering digital audio signals.

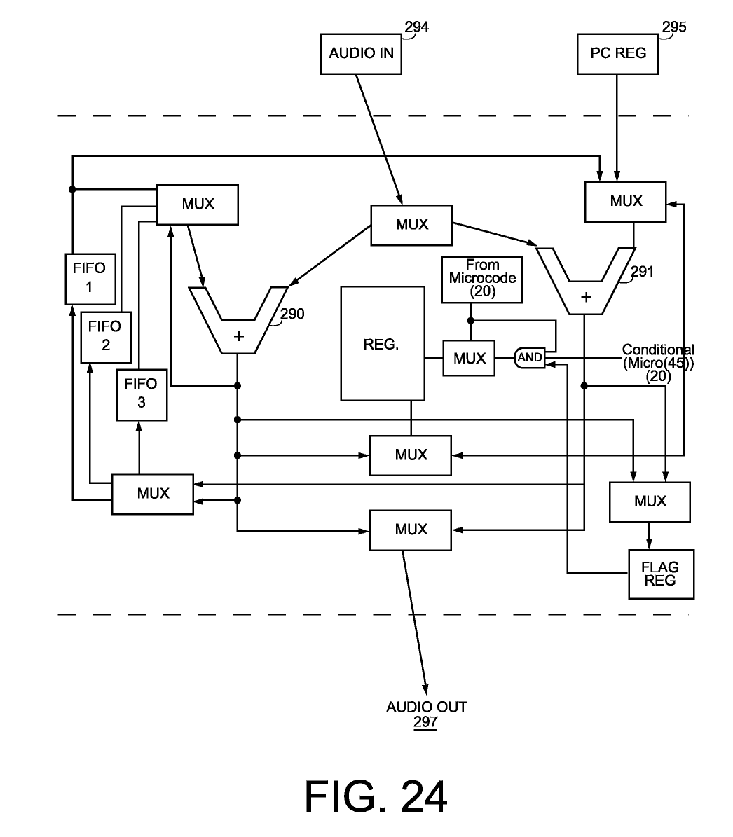

The Misc 1 node can be operated using a Microcode Engine such as that shown in FIG. 24. The Microcode Engine consists of a system using a single adder 290 and a single multiplier 291, joined by a data bus 293 and connected as above. In each sample period of a 192 KHz audio signal, the engine performs 1000 instruction cycles, each of which consists of the following actions:
a) The adder accepts its left input from either FIFO1, FIFO2, FIFO3, or its own output.
b) The adder accepts its right input from either the AUDIO input, or from the register file.
c) The adder produces a new result, based on the values on its inputs.
d) The left input of the multiplier accepts data from either the audio IN or the register file.
e) The right input of the multiplier accepts its input from either FIFO1, the PC register file (constants), or from its own output.
f) The multiplier produces a new result, based on the values on its inputs.
g) The output of either the multiplier or the adder can selectively be written to any of FIFOs 1, 2 and/or 3.
h) The output from either the multiplier or the adder can selectively be written to any location in the register file.
i) The output from either the multiplier or from the adder can selectively be written to the audio output.
j) Certain flag conditions, such as NEGATIVE or ZERO, from either the adder or the multiplier, can selectively be latched into the FLAG register. The value of this flag register can then in turn be used to signal a conditional update of a value in the register file.

The choices referred to above are controlled for each instruction cycle by a Very Long Instruction Word (VLIW). A sequence of these words is loaded into the processor, and the whole sequence is executed in each sample period. The VLIW is structured as an ordered sequence of binary information, as in the following:

| | | | | | | | | | | | | |
|---|---|---|---|---|---|---|---|---|---|---|---|---|
| A | B | C | D | E | F | G | H | I | J | . . . | Flag | Conditional |

The following assignments are made:
A=Choice of data for left adder input
B=Choice of data for right adder input
C=Choice of data for left multiplier input
D=Choice of data for right multiplier input
E=Choice of adder or multiplier, and location, to be written to Register file.
F=Choice of adder or multiplier, and output channel number, to be written to Audio Output
G=Choice of audio input channel to feed either the adder or the multiplier.
H=Choice of PC register whose contents are to be fed to the multiplier.
I, J=Control of reads/writes of FIFOs 1-3.

The Microcode Engine can flexibly be used for a great number of processing blocks, such as mixing, EQ, oscillator etc. For this reason it is a natural choice for the Misc 1 Node, which has a variety of functions. For nodes dedicated to a single process such as EQ, there are more efficient engine designs using, for example, four adders and four multipliers in parallel as described previously.

The Microcode Engine can flexibly be used for a great number of processing blocks, such as mixing, EQ, oscillator etc. For this reason it is a natural choice for the Misc 1 Node, which has a variety of functions. For nodes dedicated to a single process such as EQ, there are more efficient engine designs using, for example, four adders and four multipliers in parallel as described previously.

Miscellaneous 2 Node (Plug-in Playground) 85

A particularly valuable aspect of nodes is that they can emulate other processing devices, such as third party DSP chips or CPUs. The advantage of this is that the Crystal platform can “host” other manufacturers' specialized processing algorithms, giving a bilateral trade opportunity—to license third party signal processing algorithms within the product, or to OEM the system to other manufacturers as a “compatible” processing engine. This emulation capability is known as “virtual hardware” and the programs for creating the virtual devices within a node, including IP Cores can be outsourced from third parties.

Total Studio Connectivity Protocol (TSCP)

The Total Studio Connectivity Protocol is a means of connecting different physical locations, providing data in many formats simultaneously, and providing a timing system that allows them all to work together on the same, or different material. A typical application is a video-audio post production house, in which different rooms are used for different tasks: recording, editing, mixing, switching, color correction etc.

At any one time, several rooms may be working on different aspects of the same material—for example, a recording studio may be used for an orchestral scoring session on a film, while at the same time a person in a voice booth may be adding commentary. Both recording rooms will be controlled from one point, and all the audio channels, plus video camera feeds to compensate for lack of direct sightlines, plus headphone mixes and video program material will be exchanged between these three sites. The source of video playback may be in a central machine room, and must be controlled using RS-422 from the main control room, as well as providing its video and audio channels to all three rooms.

At another time the two recording sites may be working on completely different projects, controlled from different rooms, in which case the required connections are quite different. TSCP will act as a patching system, giving remote electronic control of the connections from moment to moment, and finding paths that minimize total latency for the system's point-to-point signal connections.

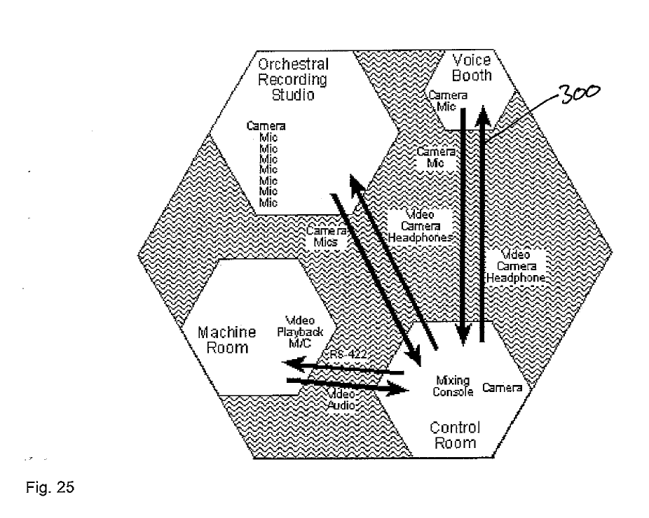

The TSCP system is illustrated in FIG. 25, and is a network of Media Highway connections, plus a control system encompassing all of them. In FIG. 4 the Media Highway connections are shown as heavy black arrows, e.g., 300, with the type of data carried by each connection listed nearby.

The Media Highway physical connections can be unidirectional point to point connection which may use optical cable, coaxial cable, standard Ethernet (CAT6), or SATA links. The type of cable used determines the bandwidth of individual links, and a system may contain a mixture of cable types designed to provide exactly the required bandwidth at the most affordable cost.

Each TSCP site is a Crystal sub-system, consisting of at least a host computer with a CME processor circuit board. A site may be as small as one I/O box with a minimal Crystal subsystem, and the capacity for just two MH connections, or as large as a control room site containing a large mixer or video switcher, with as many Media Highway connections as needed. The MH cables are connected to ports on the Crystal sub-system, and from there via nodes to the Hub of the system.

Media Highway Frame Structure

Data on Media Highway is carried in frames, which in one embodiment has the structure shown below.

| | | | | | |
|---|---|---|---|---|---|
| Timing | Video1 (SDI-HD) | Audio (48 KHz) | RS-422 | GPI | MIDI |

| | | | |
|---|---|---|---|
| Video2 (SDI-HD) | Audio (44.1 KHz) | Timecode | KVM |

| | |
|---|---|
| Header | Payload |

The frame is divided into two sections, header and payload. The header contains synchronization information. The payload contains a number of data sections, each of which can carry any type of signal required. Typical signals used in media include multiple video channels of various formats, multiple audio channels of various formats, timecode, RS-422 control signals, MIDI (Musical Instrument Digital Interface), GPIs (contact closure signals) and KVM (keyboard-video-mouse data from computers.

Media Highways can be bridged at Crystal processor boards, using the board's Hub as the switching matrix for the signals. In this way, a video signal traveling along a Media Highway from a machine room to a control room can be distributed to other rooms by making it available to different nodes serving the connecting Media Highways.

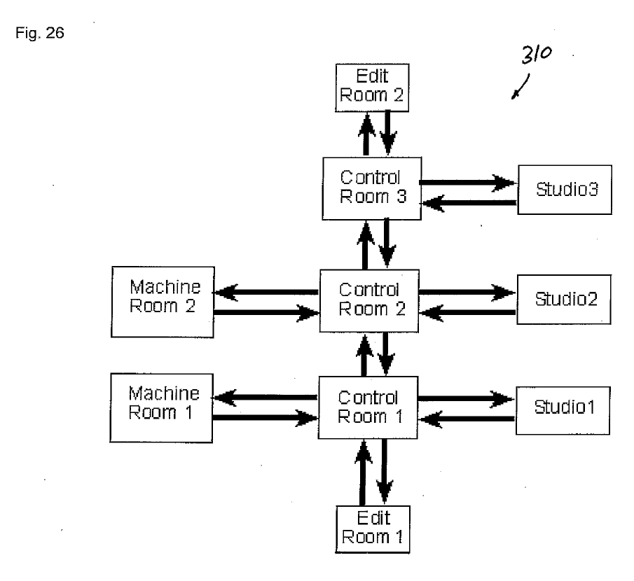

FIG. 26 shows the interconnection of sites in an exemplary typical TSCP system. Any signal can be routed or distributed from one site to any number of others, using several jumps if necessary. It is also possible to use the system for linking resources across rooms. For example, the mixing facilities in two control rooms could be combined into one powerful system, with the software calculating and executing all connections as required.

TSCP Clock Synchronisation

The timing system can be divided into two areas, data rates and system clocks. The data rate is the frequency at which data frames are transmitted in the system, and this rate may be different from the sample rate of any or all transmitted signal types. The data rate does not even need to be particularly regular, but it does need to be at least as fast as the highest sampling frequency of any transmitted data.

Data from constant-frequency formats, such as video, audio and timecode, are transmitted at the data rate frequency, although in general the latter may be different from the native frequency of the signal. For example, the master clock frequency may be 48000 Hz, while one of the data formats could be audio at 44100 Hz. This audio data will be written into a buffer at its destination at the master clock frequency, and read from the buffer at its native frequency of 41000. A delay of one sample will ensure that the sample data has changed before each read from the buffer, but for this to be true, the local 44100 Hz clock must be derived from the system master clock This is accomplished by first recovering the master clock, then converting it to all the clock frequencies needed at the destination.

The system clock must be very regular, and must be recoverable at any site on the network. That is to say, a low-jitter clock of the same frequency and at a fixed phase offset from the master clock must be able to be generated at each site. The source of the system clock can be injected at any site, and may be the output of an SPG, a video or audio machine or any other source convenient to the facility. Its frequency is not important, but generally it is chosen to be a multiple of all data sample frequencies, so that clocks at each of their frequencies can be generated by simple division of the system clock. Typical frequencies would be in the range 25 to 30 MHz.

System clocks can be regulated by a Voltage Controlled Crystal Oscillator (VCXO) which affords an extremely low jitter clock whose frequency can be “bent” upwards or downwards by applying a voltage to its Control Input.

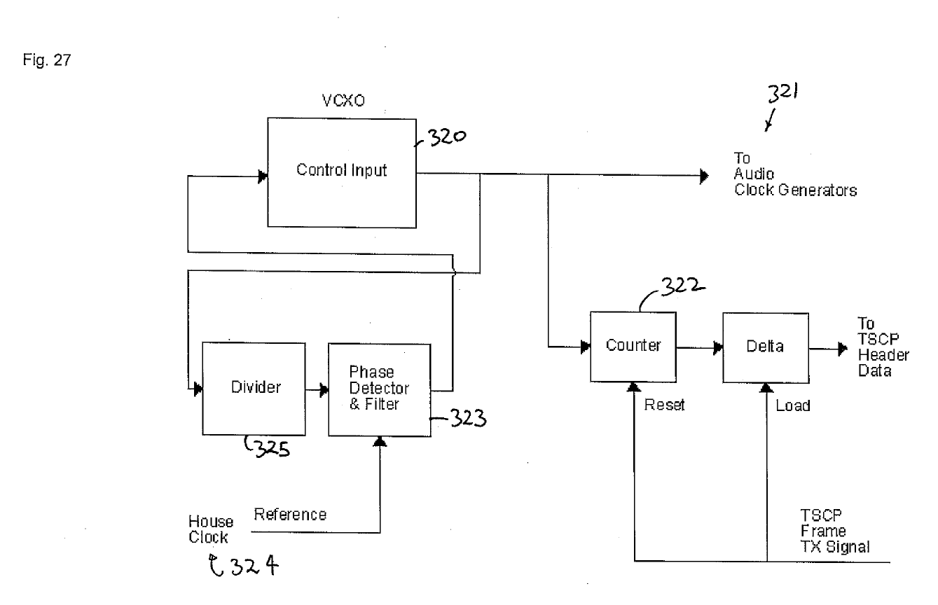

Referring to FIG. 27, there is illustrated the calculation of the Master Clock for TSCP Network, the VCXO 320 is generating a stable clock. Its output is monitored by a circuit in which it is divided to match the frequency of a reference signal, known as House Clock 324, then phase compared with the latter. A voltage is generated to pull the VCXO phase closer to that of the House Clock, but variations in this voltage are strongly filtered so that the rate of change of the voltage is slow. Once the VCXO is in the correct range, its frequency will vary slightly and slowly compared with that of the House Clock, providing a low-jitter clock for the system.

If no House Clock is present, the VCXO will be left to run free, providing a stable reference in its own right. Whether or not the VCXO is referenced, its output is fed to dividers 325 that will generate all required clocks for the various data types encountered at the Master site.

The output of the VCXO is fed to a counter 322, which is reset each time a data frame is transmitted. The current value of the counter is written to the header of each frame, telling the receiver how many system clocks have elapsed since the previous frame was sent.

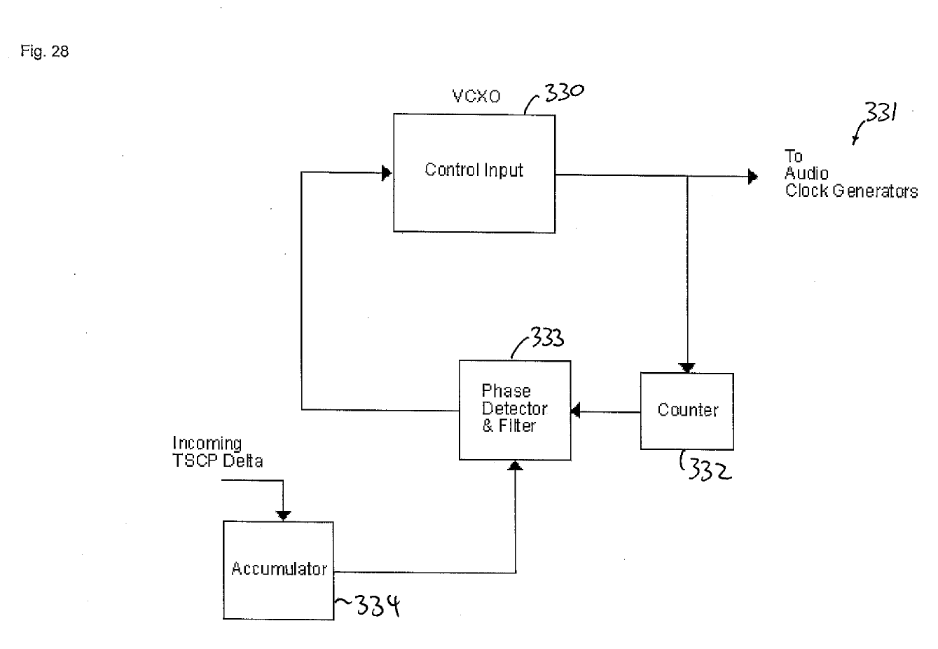

At the receiving site, the Master Clock must be recovered. As illustrated in FIG. 28, another VCXO 330 is used to generate system clocks. Its frequency will be compared to that of the VCXO at the Master site using the deltas stored in the received frames, as follows. The Master Clock deltas—the values of number of clocks elapsed since last frame—are accumulated in a counter. The accumulator 334 is allowed to overflow, and its most significant bit is monitored. A counter of the same width is fed by the local VCXO, and its most significant bit is also monitored. A phase comparator 333 compares the phase of this changing bit in the two counters, and adjusts the voltage fed to the VCXO to try and phase-match them. With strong filtering of the control voltage, a low-jitter clock can be generated in the local VCXO which is frequency-locked to the Master site VCXO.

TSCP Sync Connection

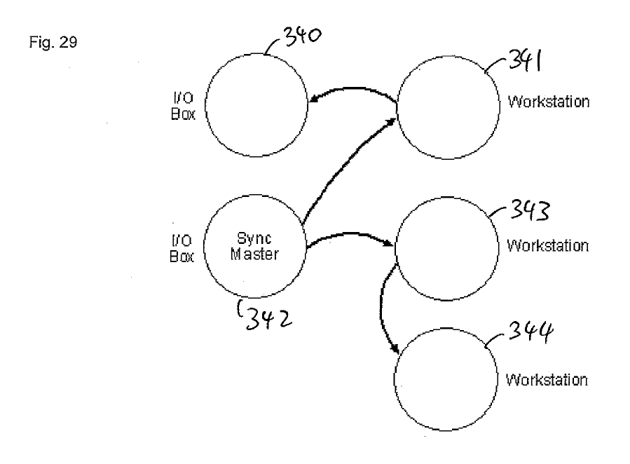

Referring to FIG. 29, in a TSCP system, a number of sites 340-344 are connected by a Media Highway. One of these sites 342 acts as the Sync Master, whose System Clock is generated locally, usually referenced to a high-quality House Clock. Its timing signal is carried to other sites, and can be transmitted from them to further sites. Each additional site in the chain is called a “tier” from a synchronization point of view. The system can support any number of tiers, with the proviso that sync signal quality may be compromised as clock frequencies decrease and numbers of tiers increase.

Media Highway Frame Transmission

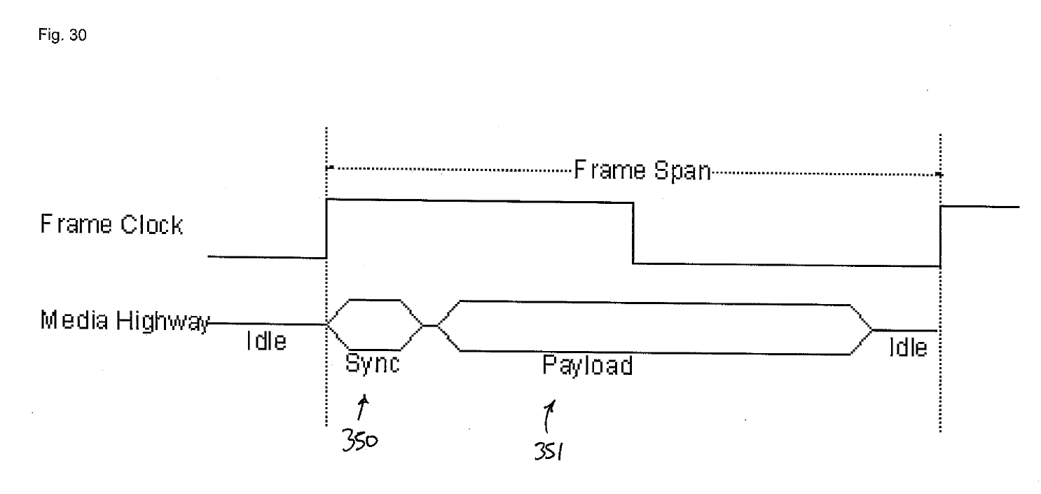

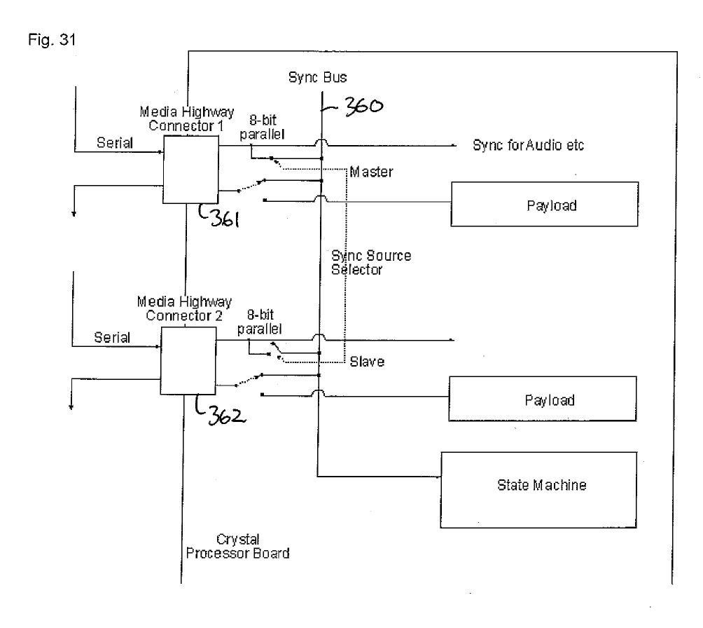

Referring to FIG. 30, information is transmitted in two sections, a sync section 350 and a payload 351 of useful data. FIG. 31 illustrates the Synchronization Across Multiple Tiers. A Crystal Processor Board may have several Media Highway connectors, e.g., 361, 362, typically four, of which two are shown. A Sync Bus 360 within the Media Processor chip is created using a simple electrical connection with no buffering. A Sync Source Selector selects which of the Media Highway connectors 361, 362 will be used as the synchronization source. In the event that this source stops transmitting, if for example the sending device is switched off, the system may be configured to switch in a “second choice” sync source.

Media Highway frames enter the input side of the connectors, while other frames exit the output side asynchronously. Every frame carries the Sync header that can be recovered and used to generate clocks at the destination.

Connector 1's input is connected to the Sync Bus, making it the Master for this Crystal Board. All Media Highway outputs become idle after delivering their payload. For each output, once its payload, and the payload of the designated Sync Input are completely delivered, the output is switched to the Sync Bus. The next time a Frame starts at the Sync Input, it is simultaneously broadcast on all outputs. After the Sync header has been transmitted, each output is switched over to the line from the buffer containing its next payload of data. Having transmitted the payload it goes idle and the cycle starts again. In this way, each output sends the same sync message, but its own individual payload.

A complication arises because the data, arriving in serial format, may need to be converted to parallel data if the frequency is high, e.g., 1 GHz or more. This is to reduce the cost of components needed to handle the data, and also to reduce RF emissions from the board. In this case, the data is converted to 8-bit parallel format on entry, and back to serial format at the exit. Such a conversion has a worst-case latency of 8 clock cycles, and because the transmissions of the different inputs and outputs are asynchronous, the total delay can be anything from zero to 16 clock cycles. This delay will vary from frame to frame, injecting a jitter of up to 16 cycles into the clock recovery circuit at the destination. This jitter can be smoothed using Phase Locked Loops or other common circuits, but only if it is a small percentage of the sync signal's frame length. If it is too large a percentage, clocks may become unstable.

There are two ways of mitigating this problem—increasing the frame frequency, or increasing the transmission line frequency. The higher the transmission frequency, the smaller 16 of its cycles are as a percentage of the frame span. The higher the frame frequency, the more data the receiving circuitry receives in any given time, so the more quickly and securely it can lock to the signal.

Increasing the transmission frequency makes the wiring more expensive, but commonly used wiring schemes of the present day can be used, and in general will yield excellent data efficiency compared with current schemes. Very high frequencies can be achieved using optical or coaxial cables, or by connecting multiple cables in parallel to increase total data transmitted.

Increasing sync frequency allows the system to achieve stable clock recovery without the expense of more exotic wiring, but at the same time it devotes more of the total transmission time to sync signals and the idle time that precedes them, so the total data transmitted is reduced.

Unless specifically stated otherwise, as apparent from the description herein, it is appreciated that throughout the specification discussions utilizing terms such as “processing,” “computing,” “calculating,” “determining” or the like, refer to the action and/or processes of a computer or computing system, or similar electronic computing device, that manipulates and/or transforms data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by a machine, e.g., a machine system, computer system, processing system that includes one or more processors that accept computer-readable—also called machine-readable—instructions, e.g., software. For any of the methods described herein, when the instructions are executed by the machine, the machine performs the method. Any machine capable of executing a set of instructions—sequential or otherwise—that specify actions to be taken by that machine are included. Thus, a typical machine may be exemplified by a typical processing system that includes one or more processors. Each processor may include one or more CPUs, a graphics processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein also encompasses a storage system such as a disk drive unit. The processing system in some configurations may include a sounds output device, and a network interface device. The memory subsystem thus includes a carrier medium that carries computer-readable instructions, e.g., software, for performing, when executed by the processing system, one or more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute carrier medium carrying computer-readable instructions.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while some diagram(s) only show(s) a single processor and a single memory that carries the computer-readable instructions, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer program that executes on a processing system, e.g., a one or more processors that are part of some of the nodes of the device, and also one or more processors that are part of the host computer. Thus, as will be appreciated by those skilled in the art, embodiments of the present invention may be embodied as a method, an apparatus such as a special purpose apparatus, an apparatus such as a data processing system, or a carrier medium, e.g., a computer program product. The carrier medium carries computer readable instructions for controlling a processing system to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program instructions embodied in the medium.

The software may further be transmitted or received over a network via the network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by the machine and that cause the machine to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media may also take the form of acoustic or light waves, such as those generated during radio wave and infrared data communications. For example, the term “carrier medium” shall accordingly be taken to include, but not be limited to, solid-state memories, optical and magnetic media, transmission media, and carrier wave signals.

It will be understood that the steps of methods discussed are performed in one embodiment by an appropriate processor (or processors) of a processing (i.e., computer) system executing instructions (code segments) stored in storage. It will also be understood that the invention is not limited to any particular implementation or programming technique and that the invention may be implemented using any appropriate techniques for implementing the functionality described herein. The invention is not limited to any particular programming language or operating system.

In the description herein, numerous specific details are set forth. However, it is understood that embodiments of the invention may be practiced without these specific details. In other instances, well-known methods, structures and techniques have not been shown in detail in order not to obscure an understanding of this description.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

Similarly, it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

All publications, patents, and patent applications cited herein are hereby incorporated by reference.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

Similarly, it is to be noticed that the term coupled, when used in the claims, should not be interpreted as being limitative to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

I claim:

1. A signal processing system including:
a first processing unit including:
a central hub interface arranged to receive a stream of signal data from an external interface and in operation to forward the stream to one or more of a plurality of configurable node processing elements; the plurality of configurable node processing elements being interconnected to the central hub interface and arranged in operation to carry out processing operations on the stream of signal data received in the hub interface to produce a node output stream of data.

2. A signal processing system as claimed in claim 1, wherein the output stream is forwarded back to the central hub interface to form another stream of signal data for further forwarding to other node processing elements by the hub.

3. A signal processing system as claimed in claim 1 wherein the central hub and the plurality of configurable node processing elements are formed within a Field Programmable Gate Array device attached to a circuit board adapted for insertion into a host computer.

4. A signal processing system as claimed in claim 1 wherein the central hub includes a dual ported memory for simultaneous receiving a first data stream and transmitting a second data stream.

5. A signal processing system as claimed in claim 1 wherein the central hub is interconnected to a broadcast bus to which each of the configurable nodes is further interconnected for the broadcasting of an output data stream to each node simultaneously.

6. A signal processing system as claimed in claim 1 wherein the central hub includes a serial to parallel unit for receiving a plurality of return signals from the plurality of nodes and converting the return signals in parallel into an overall return signal.

7. A host computer having a plurality of the first processing units of the type as set out in claim 1, the processing units being inter-networked together.

8. A networked computer system including a plurality of host computers networked together with each host computer further including a plurality of processing units networked together wherein the processing units are as set out in claim 1.

9. A system as claimed in claim 1 wherein the data streams include audio or video data.

10. A system as claimed in claim 1 wherein the node further includes:
a communications portion interconnected to the hub and including buffer storage;
a processing portion; and
a processing interface including input and output ports interconnecting the buffer storage to the processing portion;
wherein the processing portion includes a signal processing information processing unit for processing information from the input port and outputting processed information to the output port of the processing interface.

11. A system as claimed in claim 1 wherein the nodes include a set of registers for storing values wherein the registers are set by a host computer interacting with a host bus interconnected between a host computer and the registers.

12. A system as claimed in claim 1 wherein each node process data to a resolution independent of other nodes.

13. A system as claimed in claim 1 wherein the nodes include at least one of the set: an equalisation node for providing equalisation processing of the data stream;
a mixing node for mixing data streams;
a metering node for monitoring data value levels within the data stream;
a linking node for transmitting data between different processing units;
an input/output node for transmitting data from the processing unit over a network;
an Audio Stream Input/Output node for interfacing with an ASIO device;
a tracking node for providing tracking capabilities on a data stream;
a delay compensation node for compensating for relative delay between multiple input streams; and
a dynamic node for dynamically processing a range of levels within the data stream.

14. A system as claimed in claim 1 wherein the nodes include at least an equalisation node for providing equalisation processing of the data stream.

15. A system as claimed in claim 1 wherein the nodes include at least a mixing node for mixing data streams.

16. A system as claimed in claim 1 wherein the nodes include at least a metering node for monitoring data value levels within the data stream.

17. A system as claimed in claim 1 wherein the nodes include at least a linking node for transmitting data between different processing units.

18. A system as claimed in claim 1 wherein the nodes include at least an input/output node for transmitting data from the processing unit over a network.

19. A system as claimed in claim 1 wherein the nodes include at least an Audio Stream Input/Output node for interfacing with an ASIO device.

20. A system as claimed in claim 1 wherein the nodes include at least a tracking node for providing tracking capabilities on a data stream.

21. A system as claimed in claim 20 wherein tracking is conducted in the tracking node by interpolation of values in the data stream.

22. A system as claimed in claim 1 wherein the nodes include at least a delay compensation node for compensating for relative delay between multiple input streams.

23. A system as claimed in claim 1 wherein the nodes include at least a dynamic gain node for dynamically processing a range of levels within the data stream.

24. A system as claimed in claim 23 wherein changes in gain values in the dynamic gain node are gradually applied to the data stream.

25. A system as claimed in claim 24, wherein changes in the gain values asymptote to a target value.
